(19) United States
(12) Patent Application Publication
(10) Pub. No.: US 2013/0070856 A1
(43) Pub. Date: Mar. 21, 2013

(54) IMAGE PROCESSING APPARATUS AND METHOD

(71) Applicant: Kazushi Sato, Kanagawa (JP)

(72) Inventor: Kazushi Sato, Kanagawa (JP)

(21) Appl. No.: 13/699,875

(22) PCT Filed: May 27, 2011
(86) PCT No.: PCT/JP2011/062248

§ 371 Date: Nov. 26, 2012

(30) Foreign Application Priority Data
Jun. 4, 2010 (JP) 2010-129415

(51) Int. Cl. H04N 7/36

(52) U.S. Cl. 375/240.16; 375/E07.125

(57) ABSTRACT

This disclosure relates to image processing apparatuses and methods for reducing the load of motion vector information coding and decoding operations that use the correlation in the temporal direction.

In a coding mode, the motion vector information about a current small region is encoded by using the motion vector information about a reference small region located in the same position in a reference frame as the current small region and using the temporal correlation of the motion vector information, the current small region being formed by dividing a current partial region of a current frame image into small regions. If the reference small region is a small region not having its motion vector information stored in a motion vector information storage unit, a calculation unit calculates the motion vector information about the reference small region by using the motion vector information stored in the motion vector information storage unit. This invention can be applied to an image processing apparatus, for example.

### TECHNICAL FIELD

This disclosure relates to image processing apparatuses and methods, and more particularly, to an image processing apparatus and method designed to restrain increases in the load of image coding operations and decoding operations.

### BACKGROUND ART

In recent years, to handle image information as digital information and achieve high-efficiency information transmission and accumulation, apparatuses compliant with a standard, such as MPEG (Moving Picture Experts Group) for compressing image information through orthogonal transforms such as discrete cosine transforms and motion compensations by using redundancy inherent to image information, have been spreading both among broadcast stations to distribute information and among general households to receive information.

Particularly, MPEG2 (ISO (International Organization for Standardization)/IEC (International Electrotechnical Commission) 13818-2) is defined as a general-purpose image coding standard, and is applicable to interlaced images and non-interlaced images, and to standard-resolution images and high-definition images. Currently, MPEG2 is used for a wide range of applications for professionals and general consumers. According to the MPEG2 compression standard, a bit rate of 4 to 8 Mbps is assigned to an interlaced image with a standard resolution of 720×480 pixels, and a bit rate of 18 to 22 Mbps is assigned to an interlaced image with a high resolution of 1920×1088 pixels, for example, to achieve high compression rates and excellent image quality.

MPEG2 is designed mainly for high-quality image coding for broadcasting, but is not compatible with lower bit rates than MPEG1 or coding standards with higher compression rates. As mobile terminals are becoming popular, the demand for such coding standards is expected to increase in the future, and to meet the demand, the MPEG4 coding standard has been set. As for image coding standards, the ISO/IEC 14496-2 standard was approved as an international standard in December 1998.

Further, originally intended for image coding for video conferences, a standard called H.26L (ITU-T (International Telecommunication. Union Telecommunication Standardization Sector) Q6/16 VCEG (Video Coding Expert Group)) is currently being set. H.26L requires a larger amount of calculation for coding and decoding than conventional, coding standards such as MPEG2 and MPEG4, but is known for achieving higher coding efficiency. Also, as a part of the MPEG4 activity, “Joint Model of Enhanced-Compression Video Coding” is now being established as a standard for achieving higher coding efficiency by incorporating functions unsupported by H.26L into the functions based on H.26L.

On the standardization schedule, the standard was approved as an international standard under the name of H.264 and MPEG-4 Part 10 (Advanced Video Coding, hereinafter referred to as AVC) in March 2003.

In AVC image coding operations, motion vectors are encoded by using median predictions. Non-Patent Document 1 suggests a method of adaptively using “Temporal Predictor” or “Spatio-Temporal Predictor” as predicted motion vector information, in addition to “Spatial Predictor”, which is determined through a median prediction.

Meanwhile, a conventional macroblock size of 16×16 pixels is not optimal in a large frame such as a UHD (Ultra High Definition: 4000 pixels×2000 pixels) frame, which is targeted by the next-generation coding standards, Therefore, Non-Patent Document 2 suggests macroblock sizes such as 64×64 pixels and 32×32 pixels.

Specifically, according to Non-Patent Document 2, a hierarchical structure is used. While blocks of 16×16 pixels or smaller maintain compatibility with macroblocks compliant with the current AVC, larger blocks are defined as supersets of those blocks.

While Non-Patent Document 2 suggests the use of extended macroblocks for inter slices, Non-Patent Document 3 suggests the use of extended macroblocks for intra slices.

### CITATION LIST

### Non-Patent Documents

Non-Patent Document 1: Jungyoup Yang, Kwanghyun Won, Byeungwoo Jeon, Hayoon Kim, “Motion Vector Coding with Optimal PMV Selection”, VCEG-AI22, July 2008
Non-Patent Document 2 Peisong Chenn, Yan Ye, Marta Karczewicz, “Video Coding Using Extended Block Sizes”, COM16-C123-E, Qualcomm Inc.
Non-Patent Document 3: Sung-Chang Lim, Hahyun Lee, Jinho Lee, Jongho Kim, Haechul Choi, Seyoon Jeong, Jin. Soo Choi, “Intra coding using extended block size”, VCEG-AL28, July 2009

### SUMMARY OF THE INVENTION

### Problems to be Solved by the Invention

To encode motion vectors in the temporal-axis direction as in “Temporal Direct Mode” of the AVC coding standard and as suggested in Non-Patent Document 1, all the motion vector information about a reference frame needs to be stored in a memory, and there is a possibility of an increase in circuit size or load in either the case of hardware installation or the case of software installation.

This disclosure has been made in view of the above circumstances, and an object thereof is to reduce the amount of motion vector information about a reference frame to be stored in a memory for encoding motion vectors in the temporal-axis direction, and to restrain increases in the load of coding operations and decoding operations.

### Solutions to Problems

An aspect of this disclosure is an image processing apparatus that operates in a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions, the image processing apparatus including: a motion vector information storage unit configured to store motion vector information about one small region among small regions of each of partial regions in the reference frame; a calculation unit configured to calculate the motion vector information about the reference small region by using the motion vector information stored in the motion vector information storage unit, when the reference small region is a small region not having motion vector information thereof stored in the motion vector information storage unit; and a coding unit configured to encode the motion vector information about the current small region, by using the motion vector information calculated by the calculation unit and using the temporal correlation of the motion vector information.

The motion vector information storage unit may store motion vector information about one of the small regions of each one of the partial regions.

The motion vector information storage unit may store motion vector information about a small region at the uppermost left portion of each partial region.

The motion vector information storage unit may store motion vector information about a plurality of small regions of the small regions of each of the partial regions.

The motion vector information storage unit may store motion vector information about small regions at four corners of each partial region.

The calculation unit may calculate the motion vector information about the reference small region by using at least one of motion vector information that corresponds to a partial region containing the reference small region and is stored in the motion vector information storage unit, and motion vector information that corresponds to another partial region adjacent to the partial region and is stored in the motion vector information storage unit.

The calculation unit may calculate the motion vector information about the reference small region by performing an interpolating operation using motion vector information that corresponds to a partial region containing the reference small region and is stored in the motion vector information storage unit, and motion vector information that corresponds to another partial region adjacent to the partial region and is stored in the motion vector information storage unit.

The calculation unit may use values depending on distances between a representative point of the reference small region and respective representative points of the partial region containing the reference small region and the another partial region adjacent to the partial region, the values being used as weight coefficients in the interpolating operation.

The calculation unit may use values depending on sizes of the small regions to which the motion vector information used in the interpolating operation corresponds to, complexities of images in the small regions, or similarities of pixel distribution in the small regions, the values being used as weight coefficients in the interpolating operation.

An aspect of this disclosure is an image processing method implemented in an image processing apparatus compatible with a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions, the image processing method including: storing motion vector information about one small region among small regions of each of partial regions in the reference frame, the storing being performed by a motion vector information storage unit; calculating the motion vector information about the reference small region by using the stored motion vector information when the reference small region is a small region not having motion vector information thereof stored, the calculation being performed by a calculation unit; and encoding the motion vector information about the current small region, by using the calculated motion vector information and using the temporal correlation of the motion vector information, the encoding being performed by a coding unit.

Another aspect of this disclosure is an image processing apparatus that operates in a coding mode in which motion vector information about a current small region is encoded by using motion vector information about a reference small region located in the same position in a reference frame as the current small, region and using temporal correlation of the motion vector information, the current small region being formed by dividing a current partial region of a current frame image into small regions, the image processing apparatus including: a motion vector information storage unit configured to store motion vector information about one small region among small regions of each of partial regions in the reference frame; a calculation unit configured to calculate the motion vector information about the reference small region by using the motion vector information stored in the motion vector information storage unit, when the reference small region is a small region not having motion vector information thereof stored in the motion vector information storage unit; and a decoding unit configured to decode the motion vector information about the current small region, by using the motion vector information calculated by the calculation unit and using the temporal correlation of the motion vector information, the motion vector information about the current small region having been encoded in the coding mode.

The motion vector information storage unit may store motion vector information about one of the small regions of each one of the partial regions.

The motion vector information storage unit may store motion vector information about a small region at the uppermost left portion of each partial region.

The motion vector information storage unit may store motion vector information about a plurality of small regions of the small regions of each of the partial regions.

The motion vector information storage unit may store motion vector information about small regions at four corners of each partial region.

The calculation unit may calculate the motion vector information about the reference small region by using at least one of motion vector information that corresponds to a partial region containing the reference small region and is stored in the motion vector information storage unit, and motion vector information that corresponds to another partial region adjacent to the partial region and is stored in the motion vector information storage unit.

The calculation unit may calculate the motion vector information about the reference small region by performing an interpolating operation using motion vector information that corresponds to a partial region containing the reference small region and is stored in the motion vector information storage unit, and motion vector information that corresponds to another partial region adjacent to the partial region and is stored in the motion vector information storage unit.

The calculation unit may use values depending on distances between a representative point of the reference small region and respective representative points of the partial region containing the reference small region and the another partial region adjacent to the partial region, the values being used as weight coefficients in the interpolating operation.

The calculation unit may use values depending on sizes of the small regions to which the motion vector information used in the interpolating operation corresponds, complexities of images in the small regions, or similarities of pixel distribution in the small regions, the values being used as weight coefficients in the interpolating operation.

Another aspect of this disclosure is an image processing method implemented in an image processing apparatus compatible with a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions, the image processing method including: storing motion vector information about one small region among small regions of each of partial regions in the reference frame, the storing being performed by a motion vector information storage unit; calculating the motion vector information about the reference small region by using the stored motion vector information when the reference small region is a small region not having motion vector information thereof stored, the calculation being performed by a calculation unit; and decoding the motion vector information about the current small region, by using the calculated motion vector information and using the temporal correlation of the motion vector information, the motion vector information about the current small region having been encoded in the coding mode, the decoding being performed by a decoding unit.

According to an aspect of this disclosure, in a coding mode, the motion vector information about a current small region is encoded by using the motion vector information about a reference small region located in the same position in a reference frame as the current small region, the current small region being formed by dividing a current partial region of a current frame image into small regions. If the motion vector information about a small region among the small regions of each of the partial regions in the reference frame is stored, and the reference small region is a small region not having its motion vector information stored, the motion vector information about the reference small region is calculated by using the stored motion vector information, and the motion vector information about the current small region is encoded by using the calculated motion vector information and using the motion vector information temporal correlation.

According to another aspect of this disclosure, in a coding mode, the motion vector information about a current small region is encoded by using the motion vector information about a reference small region located in the same position in a reference frame as the current small region, the current small region being formed by dividing a current partial region of a current frame image into small regions. If the motion vector information about a small region among the small regions of each of the partial regions in the reference frame is stored, and the reference small region is a small region not having its motion vector information stored, the motion vector information about the reference small region is calculated by using the stored motion vector information, and the motion vector information about the current small region, which has been encoded in the coding mode, is decoded by using the calculated motion vector information and using the motion vector information temporal correlation.

### Effects of the Invention

According to this disclosure, images can be processed. Particularly, in a coding mode for encoding motion vector information by using the correlation in the temporal-axis direction, the load of coding operations and decoding operations can be reduced.

### BRIEF DESCRIPTION OF DRAWINGS

FIG. 1 is a block diagram showing an example principal structure of an image coding apparatus.

FIG. 2 is a diagram showing an example of a motion predicting/compensating operation with decimal pixel accuracy.

FIG. 3 is a diagram showing examples of macroblocks,

FIG. 4 is a diagram for explaining an example of a median operation.

FIG. 5 is a diagram for explaining an example case of multi reference frames.

FIG. 6 is a diagram for explaining an example of a temporal direct mode.

FIG. 7 is a diagram for explaining an example of a motion vector coding method suggested in Non-Patent Document 1.

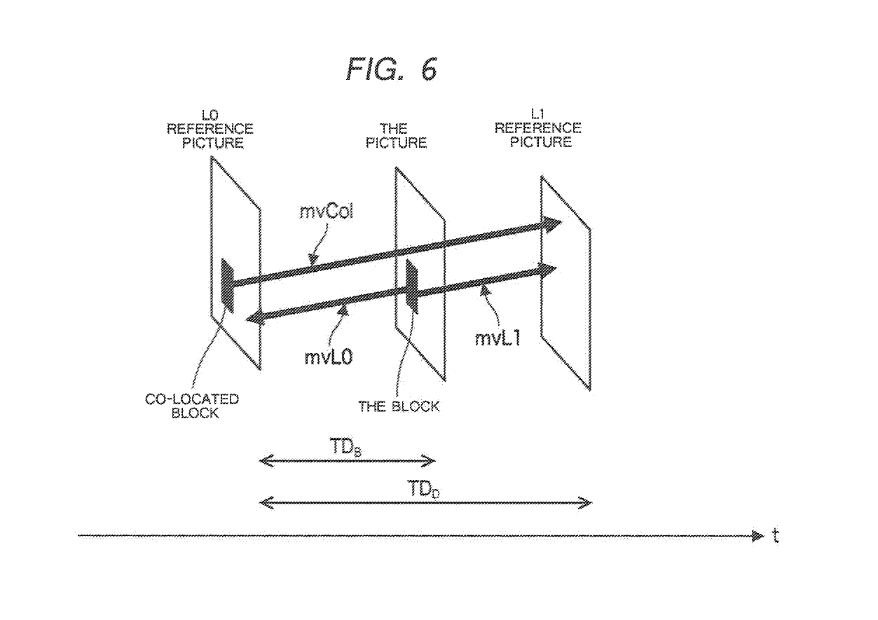

FIG. 6 is a diagram showing other examples of macroblocks.

FIG. 9 is a diagram for explaining an example of a motion vector coding method.

FIG. 10 is a diagram for explaining the example of a motion vector coding method.

FIG. 11 is a diagram for explaining the example of a motion vector coding method.

FIG. 12 is a diagram showing example structures of sub macroblocks.

FIG. 13 is a block diagram showing a specific example structure of the temporal motion vector coding unit.

FIG. 14 is a flowchart for explaining an example flow in a coding operation.

FIG. 15 is a flowchart for explaining an example flow in an inter motion predicting operation.

FIG. 16 is a flowchart for explaining an example flow in a temporal motion vector coding operation.

FIG. 17 is a block diagram showing an example principal structure of an image decoding apparatus.

FIG. 18 is a flowchart for explaining an example flow in a decoding operation.

FIG. 19 is a flowchart for explaining an example flow in a predicting operation.

FIG. 20 is a diagram for explaining another example of a motion vector coding method.

FIG. 21 is a block diagram showing an example principal structure of a personal computer.

FIG. 22 is a block diagram showing an example principal structure of a television receiver.

FIG. 23 is a block diagram showing an example principal structure of a portable telephone.

FIG. 24 is a block diagram showing an example principal structure of a hard disk recorder.

FIG. 25 is a block diagram showing an example principal structure of a camera.

### MODE FOR CARRYING OUT THE INVENTION

The following is a description of modes for carrying out this technique (hereinafter referred to as embodiments). Explanations will be made in the following order

1. First Embodiment (Image coding apparatus)
2. Second Embodiment (Image decoding apparatus)
3. Third Embodiment (Personal computer)
4. Fourth Embodiment (Television receiver)
5. Fifth Embodiment (Portable telephone)
6. Sixth Embodiment (Hard disk recorder)

### 7. Seventh Embodiment (Camera)

### 1. First Embodiment

### [Image Coding Apparatus]

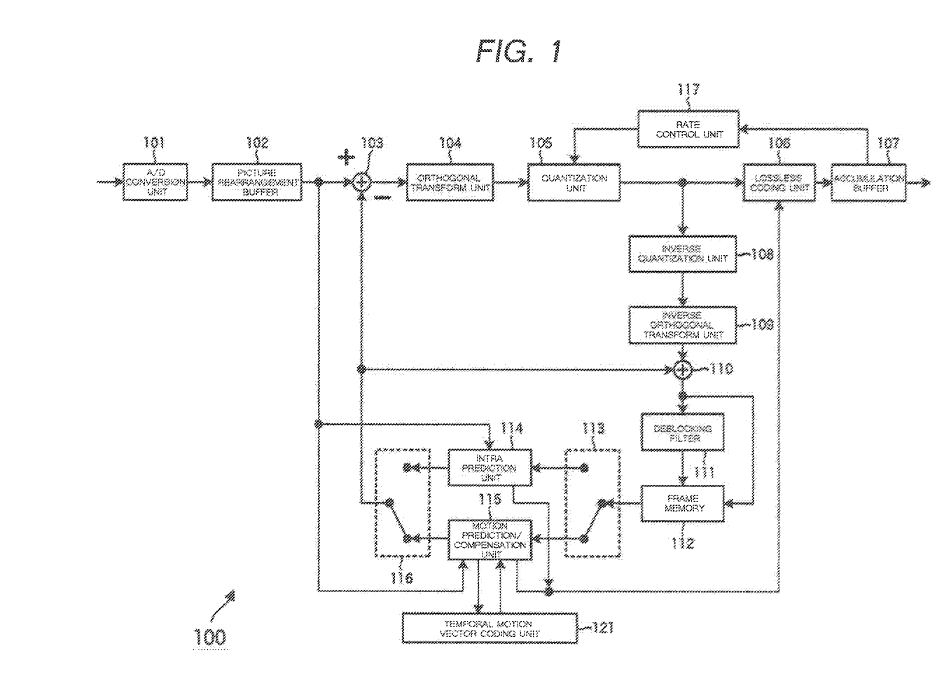

FIG. 1 illustrates the structure of an embodiment of an image coding apparatus as an image processing apparatus.

The image coding apparatus 100 illustrated in FIG. 1 is a coding apparatus that encodes images in the same manner as the H.264 and MPEG (Moving Picture Experts Group) 4 Part 10 (AVC (Advanced Video Coding)) (hereinafter referred to as “H.264/AVC”) standard. However, the image coding apparatus 100 stores only the motion vector value corresponding to a sub macroblock of each one macroblock in a reference frame into a memory, and generates motion vectors of other blocks included in the macroblock by a calculation using motion vector values stored in the memory. By doing so, the image coding apparatus 100 reduces the amount of motion vector information about the reference frame to be stored in the memory for motion vector coding in the temporal-axis direction.

In the example illustrated in FIG. 1, the image coding apparatus 100 includes an A/D (Analog/Digital) conversion unit 101, a picture rearrangement buffer 102, a calculation unit 103, an orthogonal transform unit 104, a quantization unit 105, a lossless coding unit 106, and an accumulation buffer 107. The image coding apparatus 100 also includes an inverse quantization unit 108, an inverse orthogonal transform unit 109, a calculation unit 110, a deblocking filter 111, a frame memory 112, a select unit 113, an intra prediction unit 114, a motion prediction/compensation unit 115, a select unit 116, and a rate control unit 117.

The image coding apparatus 100 further includes a temporal motion vector coding unit 121.

The A/D conversion unit 101 performs an A/D conversion on input image data, and outputs and stores the converted image data into the picture rearrangement buffer 102.

The picture rearrangement buffer 102 rearranges the image in frame order for coding in accordance with the GOP (Group of Picture) structure, instead of stored display order. The picture rearrangement buffer 102 supplies the frame-order rearranged image to the calculation unit 103. The picture rearrangement buffer 102 also supplies the frame-order rearranged image to the intra prediction unit 114 and the motion prediction/compensation unit 115.

The calculation unit 103 subtracts a predicted image supplied from the intra prediction unit 114 or the motion prediction/compensation unit 115 via the select unit 116, from an image read from the picture rearrangement buffer 102. The calculation unit 103 outputs the difference information to the orthogonal transform unit 104.

In the case of an image to be subjected to intra coding, for example, the calculation unit 103 subtracts the predicted image supplied from the intra prediction unit 114 from the image read from the picture rearrangement buffer 102. In the case of an image to be subjected to inter coding, for example, the calculation unit 103 subtracts the predicted image supplied from the motion prediction/compensation unit 115 from the image read from the picture rearrangement buffer 102.

The orthogonal transform unit 104 performs an orthogonal transform, such as a discrete cosine transform or a Karhunen-Loeve transform, on the difference information supplied from the calculation unit 103, and supplies the transform coefficient, to the quantization unit 105.

The quantization unit 105 quantizes the transform coefficient output from the orthogonal transform unit 104. Based on information supplied from the rate control unit 117, the quantization unit 105 sets a quantization parameter, and performs quantization. The quantization unit 105 supplies the quantized transform coefficient to the lossless coding unit 106.

The lossless coding unit 106 performs lossless coding, such as variable-length coding or arithmetic coding, on the quantized transform coefficient.

The lossless coding unit 106 obtains information indicating an intra prediction or the like from the intra prediction unit 114, and obtains information indicating an inter prediction mode, motion vector information, or the like from the motion prediction/compensation unit 115. The information indicating an intra prediction an intra-picture prediction) will be hereinafter also referred to as intra prediction mode information. The information indicating the information mode indicating an inter prediction (an inter-picture prediction) will be hereinafter also referred to as inter prediction mode information.

The lossless coding unit 106 encodes the quantized transform coefficient, and incorporates (multiplexes) the respective kinds of information such as the filter coefficient, the intra prediction mode information, the inter prediction mode information, and the quantized parameter, into the header information of encoded data. The lossless coding unit 106 supplies the encoded data obtained through the coding to the accumulation buffer 107, and accumulates the encoded data in the accumulation buffer 107.

At the lossless coding unit 106, a lossless coding operation such as variable-length coding or arithmetic coding is performed. The lossless coding may be CAVLC (Context-Adaptive Variable Length Coding) specified in the H.264/AVC standard, for example. The arithmetic coding may be CABAC (Context-Adaptive Binary Arithmetic Coding) or the like.

The accumulation buffer 107 temporarily holds the encoded data supplied from the lossless coding unit 106, and, at a predetermined time, outputs an encoded image that is an image encoded in accordance with the H.264/AVC standard to a recording apparatus or a transmission path (not shown) located in a later stage, for example.

The transform coefficient quantized by the quantization unit 105 is also supplied to the inverse quantization unit 108. The inverse quantization unit 108 inversely quantizes the quantized transform coefficient by using a method compatible with the quantization performed by the quantization unit 105. The inverse quantization unit 108 supplies the resultant transform coefficient to the inverse orthogonal transform unit 109.

The inverse orthogonal transform unit 109 performs an inverse orthogonal transform on the supplied transform coefficient by using a method compatible with the orthogonal transforming operation performed by the orthogonal transform unit 104. The output subjected to the inverse orthogonal transform (the decoded difference information) is supplied to the calculation unit 110.

The calculation unit 110 adds the predicted image supplied from the intra prediction unit 114 or the motion prediction/compensation unit 115 via the select unit 116 to the inverse orthogonal transform result supplied from the inverse orthogonal transform unit 109, or the decoded difference information. In this manner, the calculation unit 110 obtains an image that is locally decoded (a decoded image).

In a case where the difference information corresponds to an image to be subjected to intra coding, for example, the calculation unit 110 adds the predicted image supplied from the intra prediction unit 114 to the difference information. In a case where the difference information corresponds to an image to be subjected to inter coding, for example, the calculation unit 110 adds the predicted image supplied from the motion prediction/compensation unit 115 to the difference information.

The addition result is supplied to the deblocking filter 111 or the frame memory 112.

The deblocking filter 111 performs a deblocking filtering operation to remove block distortions from a decoded image where necessary, and also performs a loop filtering operation using a Wiener filter, for example, to improve image quality where necessary. The deblocking filter 111 divides respective pixels into classes, and performs appropriate filtering on each of the classes. The deblocking filter 111 supplies the filtering result to the frame memory 112.

At a predetermined time, the frame memory 112 outputs a stored reference image to the intra prediction unit 114 or the motion prediction/compensation unit 115 via the select unit 113.

In the case of an image to be subjected to intra coding, for example, the frame memory 112 supplies a reference image to the intra prediction unit 114 via the select unit 113. In the case of an image to be subjected to inter coding, for example, the frame memory 112 supplies a reference image to the motion prediction/compensation unit 115 via the select unit 113.

In a case where the reference image supplied from the frame memory 112 is an image to be subjected to intra coding, the select unit 113 supplies the reference image to the intra prediction unit 114. In a case where the reference image supplied from the frame memory 112 is an image to be subjected to inter coding, the select unit 113 supplies the reference image to the motion prediction/compensation unit 115.

The intra prediction unit 114 makes intra predictions (intra-picture predictions) to generate predicted images, using pixel values in the picture. The intra prediction unit 114 makes the intra predictions in more than one mode (intra prediction modes).

The intra prediction unit 114 generates predicted images in all the intra prediction modes, evaluates the respective predicted images, and selects the optimum mode. After selecting the optimum intra prediction mode, the intra prediction unit 114 supplies the predicted image generated in the optimum mode to the calculation unit 103 and the calculation unit 110 via the select unit 116.

As described above, the intra prediction unit 114 also supplies the information such as the intra prediction mode information indicating the selected intra prediction mode to the lossless coding unit 106 where necessary.

The motion prediction; compensation unit 115 makes motion predictions about an image to be subjected to inter coding, using an input image supplied from the picture rearrangement buffer 102 and the reference image supplied from the frame memory 112 via the select unit 113. The motion prediction/compensation, unit 115 performs a motion compensating operation on detected motion vectors, and generates predicted images (inter prediction image information).

The motion prediction/compensation unit 115 performs an inter predicting operation in all possible inter prediction modes, and generates predicted images. For example, the motion prediction/compensation unit 115 causes the temporal motion vector coding unit 121 to perform a motion vector information, coding operation using the correlation in the temporal-axis direction.

The motion prediction/compensation unit 115 supplies the generated predicted images to the calculation unit 103 and the calculation unit 110 via the select unit 116.

The motion prediction/compensation unit 115 supplies the inter prediction mode information indicating the selected inter prediction mode, and motion vector information indicating a calculated motion vector to the lossless coding unit 106.

In the case of an image to be subjected to intra coding, the select unit 116 supplies the output from the intra prediction unit 114 to the calculation unit 103 and the calculation unit 110. In the case of an image to be subjected to inter coding, the select unit 116 supplies the output from the motion prediction/compensation unit 115 to the calculation unit 103 and the calculation unit 110.

Based on compressed images accumulated in the accumulation buffer 107, the rate control unit 117 controls the rate of the quantization performed by the quantization unit 105, so as to prevent overflows and under flows.

The temporal motion vector coding unit 121 encodes the motion vector information, using the motion vector information correlation in the temporal-axis direction, in response to a request from the motion prediction/compensation unit 115.

[Motion Predicting/Compensating Operations with Minority Pixel. Accuracy]

In a coding standard such as MPEG-2, motion predicting/compensating operations with ½ pixel accuracy are performed through linear interpolating operations. In the AVC coding standard, on the other hand, motion predicting/compensating operations with ¼ pixel accuracy are performed by using a 6-tap FIR filter, and a higher coding efficiency is achieved through such operations.

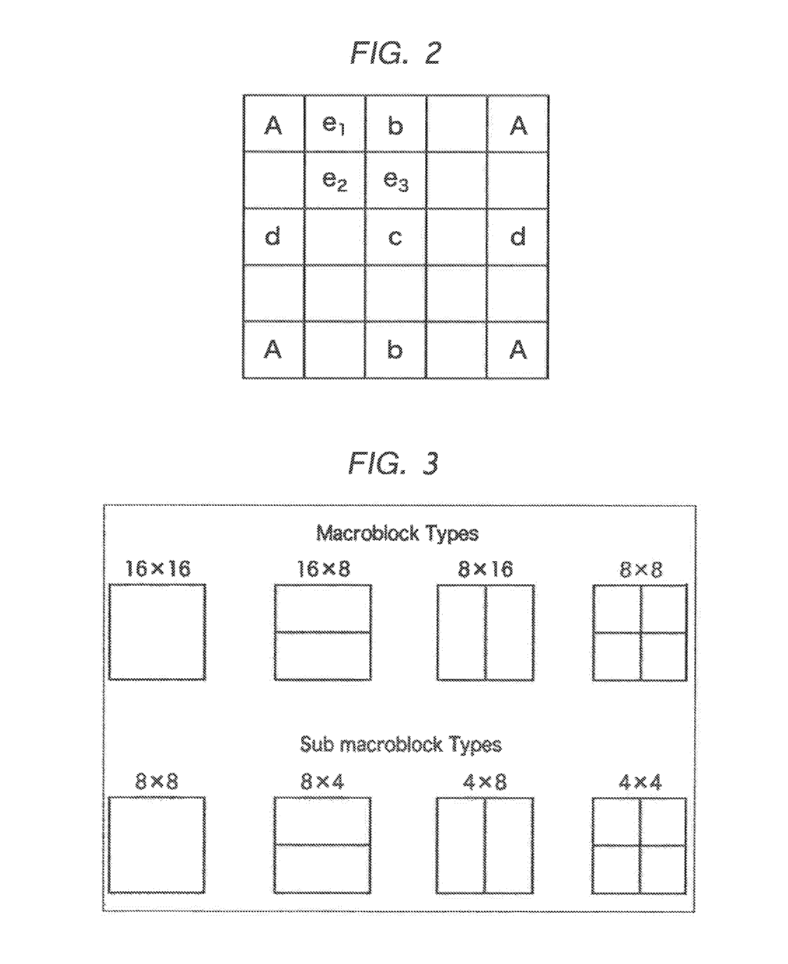

FIG. 2 is a diagram for explaining an example of a motion predicting/compensating operation with ¼ pixel accuracy specified in the AVC coding standard. In FIG. 2 each square represents one pixel. Among the pixels, each “A” indicates the location of an integer-accuracy pixel stored in the frame memory 112, b, c, and d indicate the locations of ½ pixel accuracy, and e1, e2, and e3 indicate the locations of ¼ pixel accuracy.

In the following, a function Clip1( ) is defined as in the following equation (1)

$$\begin{matrix}[ Equation 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

In a case where an input image has 8-bit accuracy, for example, the value of max-pix in the equation (1) is 255.

The pixel values in the locations of b and d are generated as expressed by the following equations (2) and (3) using a 6-tap FIR filter:

[Equation 2]

F=A₋₂−5·A₋₁+20·A₀+20·A₁−5·A₂+A₃ (2)

[Equation 3]

b,d=clip1((F+16)>>5) (3)

The pixel value in the location of c is generated as expressed by the following equations (4) through (6) using 6-tap FIR filters in the horizontal direction and the vertical direction

[Equation 4]

F=b₋₂−5·b₋₁+20·b₀+20·b₁−5·b₂+b₃ (4)

or

[Equation 5]

F=d₋₂−5·d₋₁+20·d₀+20·d₁−5·d₂+d₃ (5)

[Equation 6]

c=clip((F+512)>>10) (6)

The clipping operation is performed only once at last, after product-sum operations are performed in both the horizontal direction and the vertical direction.

Further, e1 through e3 are generated by linear interpolations as expressed by the following equations (7) through (9)

[Equation 7]

e₁=(A+b+1)>>1 (7)

[Equation 8]

e₂=(b+d+1)>>1 (8)

[Equation 9]

e₃=(b+c+1)>>1 (9)

### [Motion Predicting/Compensating Operations]

In motion predicting/compensating operations in MPFG-2, 16×16 pixels form one unit in a frame motion compensating mode, and 16×8 pixels form one unit in a field motion compensating mode in which a motion predicting/compensating operation is performed on both a first field and a second field.

In AVC, on the other hand, each macroblock formed with 16×16 pixels is divided into 16×16, 16×8, 8×16, or 6×8 partitions as shown in FIG. 3, and sub macroblocks can have motion vector information independently of one another. Further, each 8×8 partition can be divided into 8×6, 8×4, 4×8, or 4×4 sub macroblocks, as shown in FIG. 3, and the sub macroblocks can have motion vector information independently of one another.

In the AVC image coding standard, however, there is a possibility that an enormous amount of vector information may be generated when such a motion predicting/compensating operation is about to be performed, as in the case of MPEG-2. Coding the generated motion vector information as it is will lead to a decrease in coding efficiency.

To solve such a problem, a decrease in coded motion vector information is realized in AVC image coding by the following method.

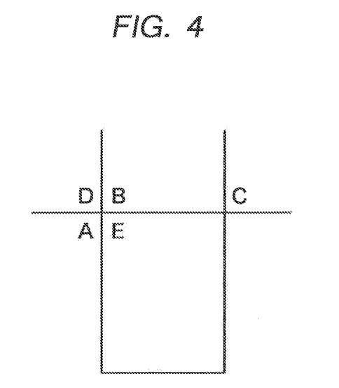

Each straight line shown in FIG. 4 indicates a boundary between motion compensation blocks. In FIG. 4, E represents the motion compensation block to be encoded, and A through D each represent an already encoded motion compensation blocks adjacent to E.

Where X is A, B, C, D, or E, the motion vector information about X is set as mvₓ.

First, using the motion vector information about the motion compensation blocks A, B, and C, predicted motion vector information pmv_{E} about the motion compensation block E is generated through a median operation as expressed by the following equation (10):

[Equation 10]

pmv_{E}=med(mv_{A},mv_{B},mv_{C}) (10)

In a case where the information about the motion compensation block C is “unavailable” due to its location at a corner of the image, for example, the information about the motion compensation block D is used in place of the information about the motion compensation block C.

Data mvd_{E} to be encoded as the motion vector information about the motion compensation block E in image compression information is generated by using pmv_{E} as expressed by the following equation (11);

[Equation 11]

mvd_{E}=mv_{E}−pmv_{E} (11)

In an actual operation, the horizontal components and the vertical components in the motion vector information are subjected to processing independently of each other.

AVC also specifies a standard called Multi-Reference Frame, which is not specified in the conventional image coding standards such as MPEG-2 and H.263.

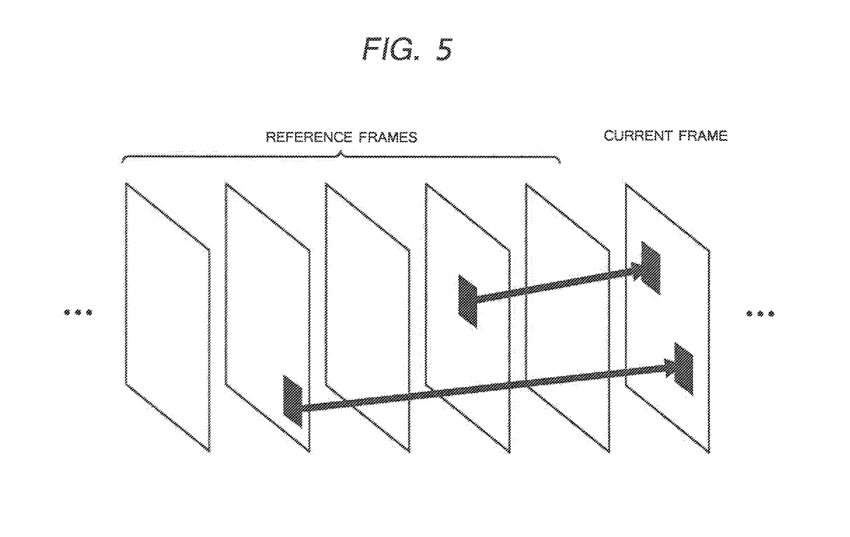

Referring now to FIG. 5, Multi-Reference Frame specified in AVC is described.

In MPEG-2 and H.263, a motion predicting/compensating operation is performed on a P-picture by referring only to one reference frame stored in a frame memory. In AVC, on the other hand, reference frames are stored in memories, and it is possible to refer to a different memory for each macroblock, as shown in FIG. 5.

The amount of motion vector information about a B-picture is enormous, but modes called “direct modes” are prepared in AVC.

In a direct mode, motion vector information is not stored in image compression information. In an image decoding apparatus, the motion vector information about the block is calculated from the motion vector information about the adjacent blocks or from the motion vector information about a co-located block that is the block located in the same position as the current block in the reference frame.

There are two types of direct modes: spatial direct mode and temporal direct mode. It is possible to switch between those two modes for each slice.

In the spatial direct mode, the motion vector information mv_{E} about the current motion compensation block E is calculated as expressed by the following equation (12):

mv_{E}=pmv_{E} (12)

That is, motion vector information generated through a median prediction is used for the block.

Referring now to FIG. 6, the temporal direct mode is described.

In FIG. 6, in a L0 reference picture, the block located at the address in the same space as the block is a co-located block, and the motion vector information in the co-located block is denoted by nw_{col}. The distance between the picture and the L0 reference picture on the temporal axis is denoted by TD_{B}, and the distance between the L0 reference picture and a L1 reference picture on the temporal axis is denoted by TD_{D}.

At this point, the motion vector information mv_{L0} of L0 and the motion vector information mv_{L1} of L1 in the picture are calculated as expressed by the following equations (13) and (14):

$$\begin{matrix}[ Equation 12 ] & \\ {mv}_{L 0} = \frac{{TD}_{B}}{{TD}_{D}} {mv}_{col} & ( 13 ) \\ [ Equation 13 ] & \\ {mv}_{L 1} = \frac{{TD}_{D} - {TD}_{B}}{{TD}_{D}} {mv}_{col} & ( 14 )\end{matrix}$$

Since the AVC image compression information does not contain information TD indicating a distance along the temporal axis, the calculations expressed by the above equations (12) and (13) are performed by using a POC (Picture Order Count).

Also, in the AVC image compression information, the direct modes can be defined for each 16×16 pixel macroblock or each 8×8 pixel block.

### [Prediction Mode Selection]

In the AVC coding standard, it is critical to select an appropriate prediction mode in achieving a higher coding efficiency.

An example of the selection method is a method stored in H.264/MPEG-4 AVC reference software (available at “http://iphome.hhi.de/suehring/tml/index.htm”) called JM (Joint Model).

In the JM, it is possible to select from the two mode determining methods described below: a high complexity mode and a low complexity mode. In each of the modes, the cost function value as to each prediction mode is calculated, and the prediction mode that minimizes the cost function value is selected as the optimum mode for the sub macroblock or the macroblock.

The cost function in the high complexity mode is expressed by the following equation (15):

Cost(ModeεΩ)=D+λ*R (15)

Here, Ω represents the universal set of candidate modes for encoding the block or macroblock, and D represents the difference energy between a decoded image and an input image in a case where coding is performed in the prediction mode, λ represents the Lagrange's undetermined multiplier provided as the quantization parameter function, and R represents the total coding amount including orthogonal transform coefficients in a case where coding is performed in the mode.

That is, to perform coding in the high complexdty mode, a provisional coding operation needs to be performed once in all the candidate modes to calculate the above parameters D and R, and therefore, a larger calculation amount is required.

The cost function in the low complexity mode is expressed by the following equation (16):

Cost(ModeεΩ)=D+QP2Quant(QP)*HeaderBit (16)

Here, D differs from that in the high complexity mode, and represents the difference energy between a predicted image and an input image. QP2Quant(QP) represents the function of the quantization parameter QP, and Header Bit represents the amount of coding related to information that excludes orthogonal transform coefficients and belongs to Header, such as motion vectors and modes.

That is, in the low complexity mode, a predicting operation needs to be performed for each of the candidate modes, but a decoded image is not required. Therefore, there is no need to perform a coding operation.

Accordingly, the calculation amount is smaller than that in the high complexity mode.

To improve the motion vector coding through a median prediction as described above with reference to FIG. 4, Non-Patent Document 1 suggests the following method.

That is, it is possible to adaptively use a “temporal predictor” or a “spatio-temporal predictor” described below as predicted motion vector information, as well as a “spatial predictor” determined through a median prediction as defined in AVC.

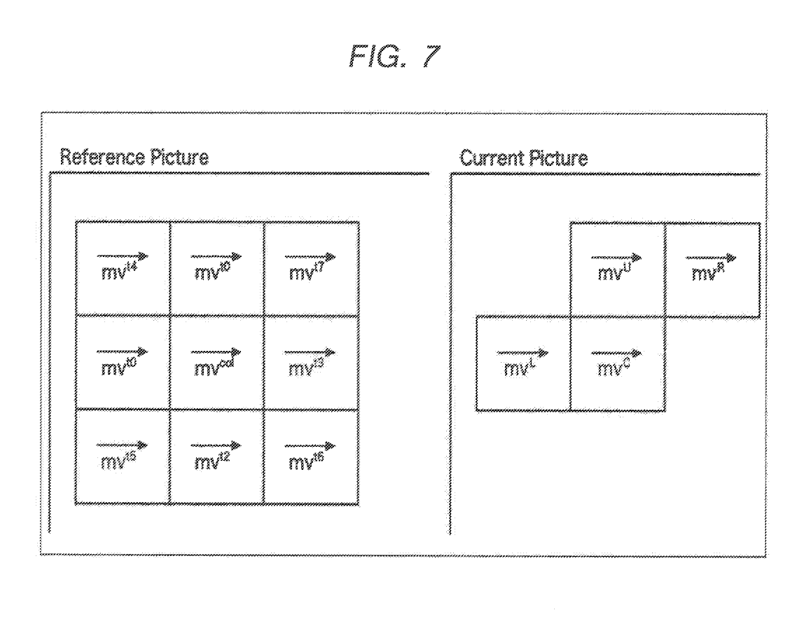

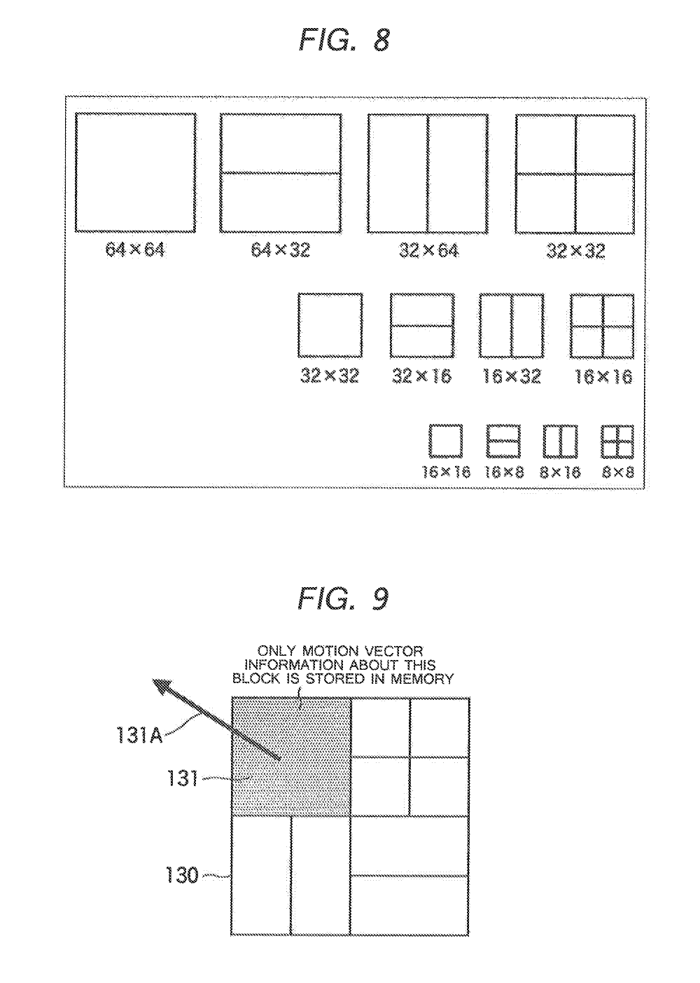

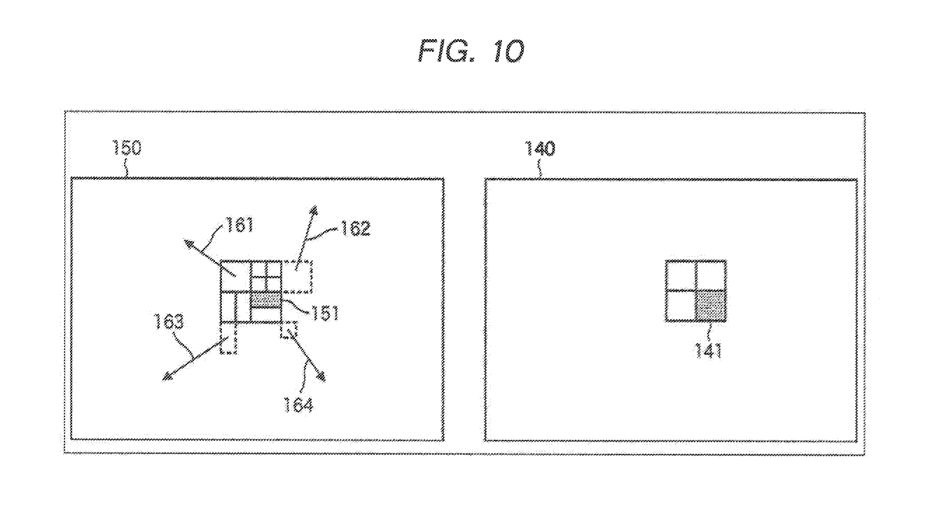

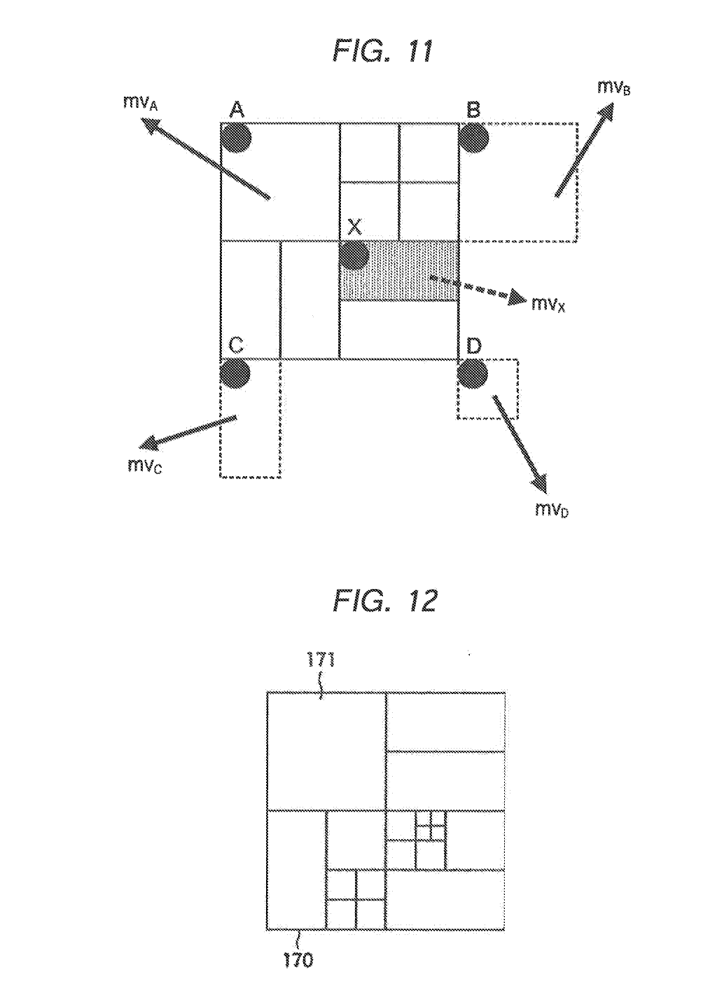

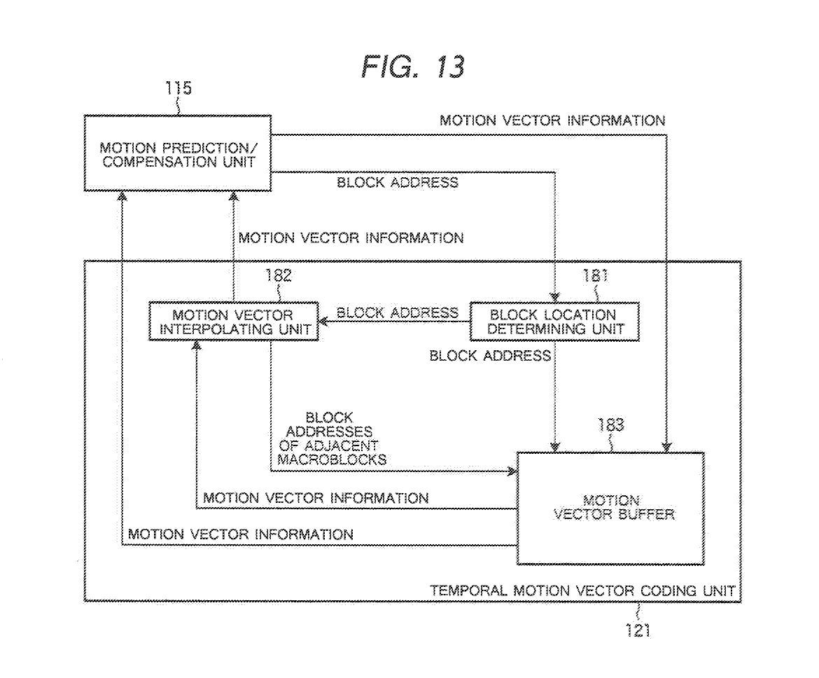

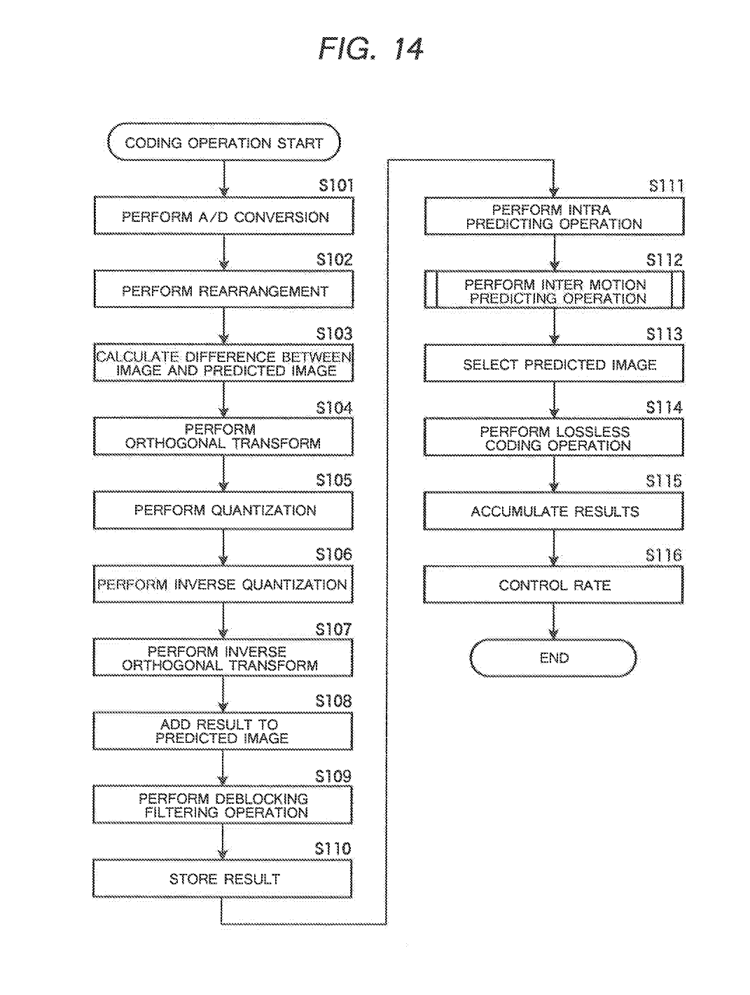

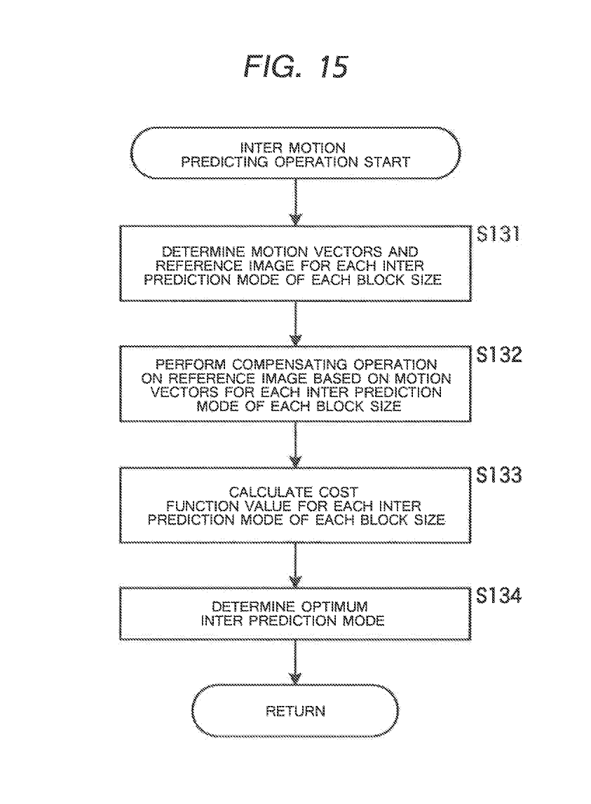

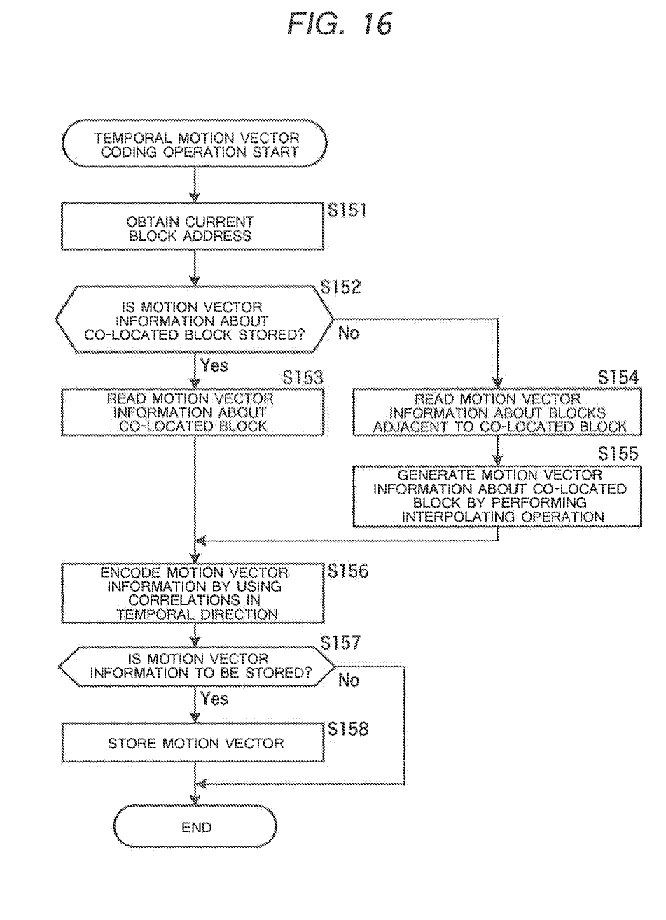

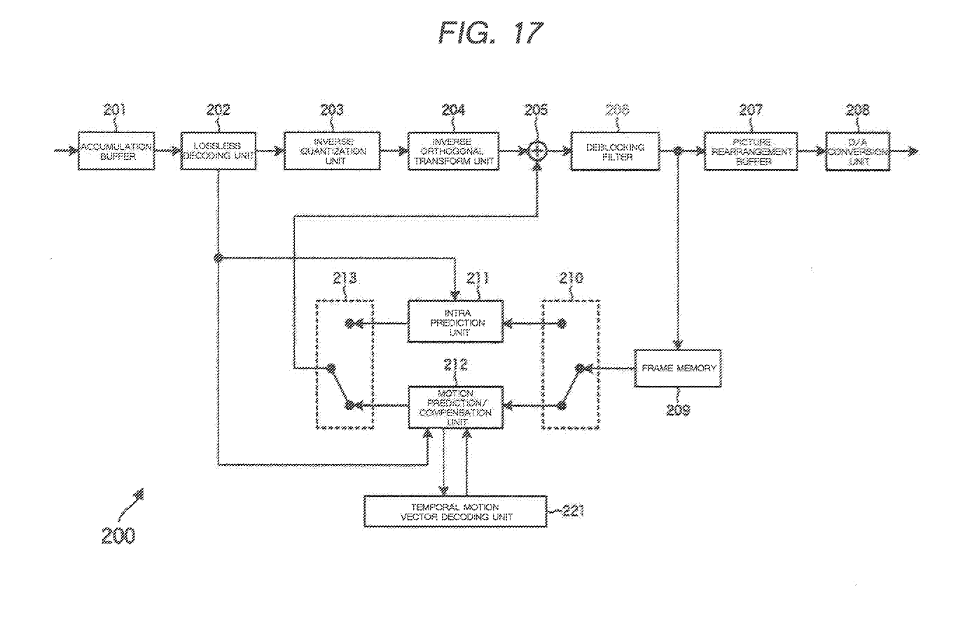

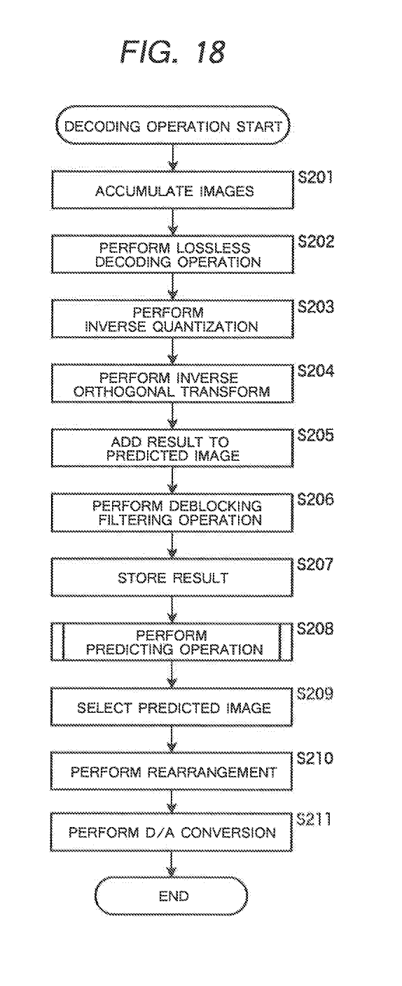

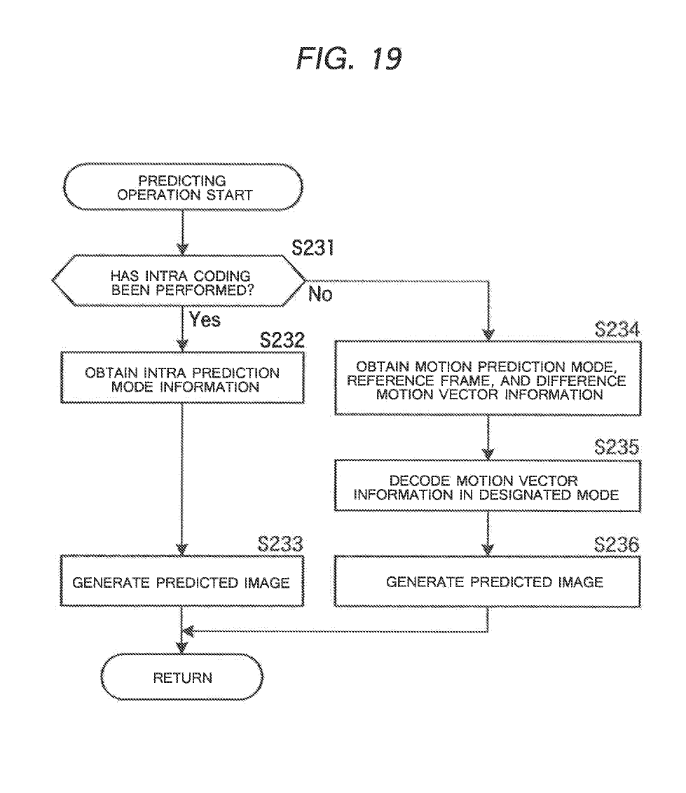

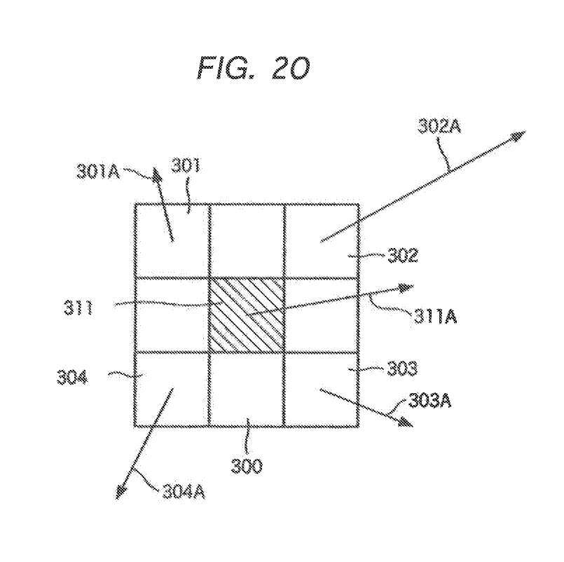

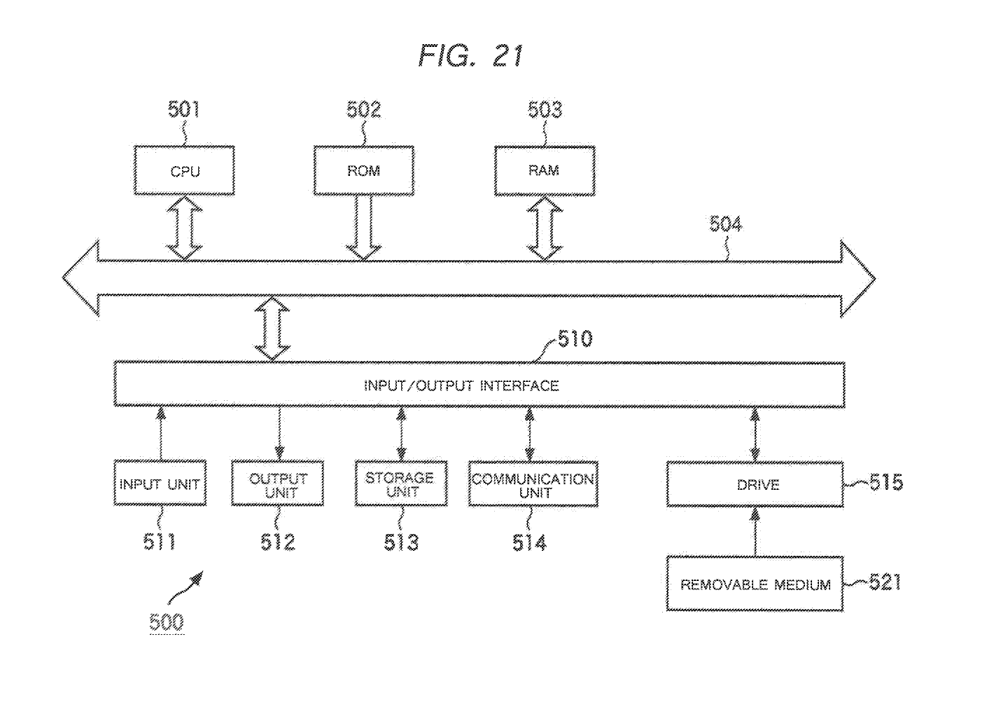

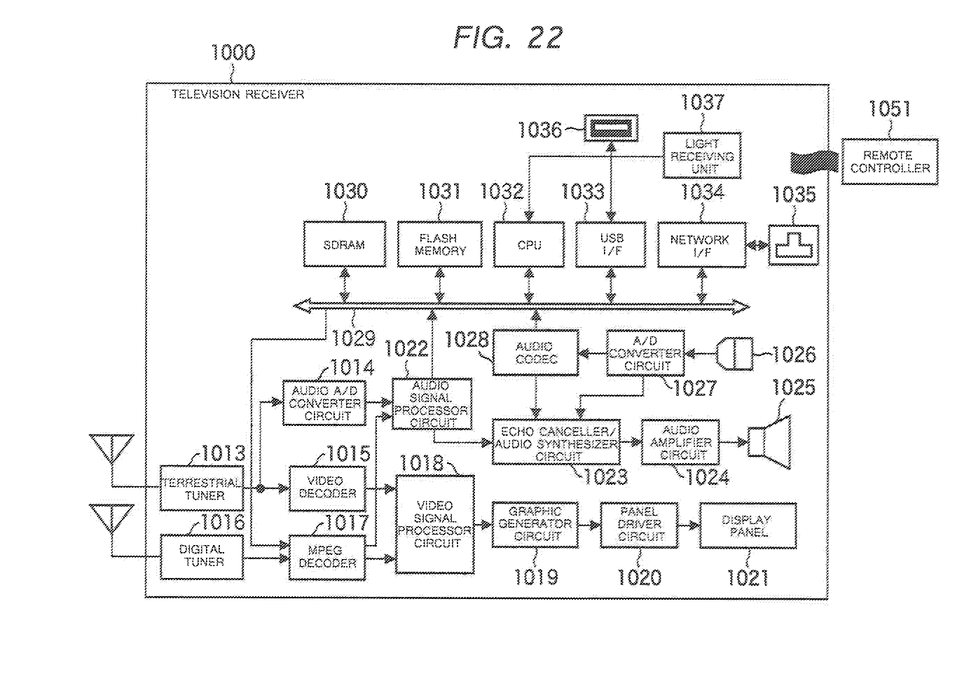

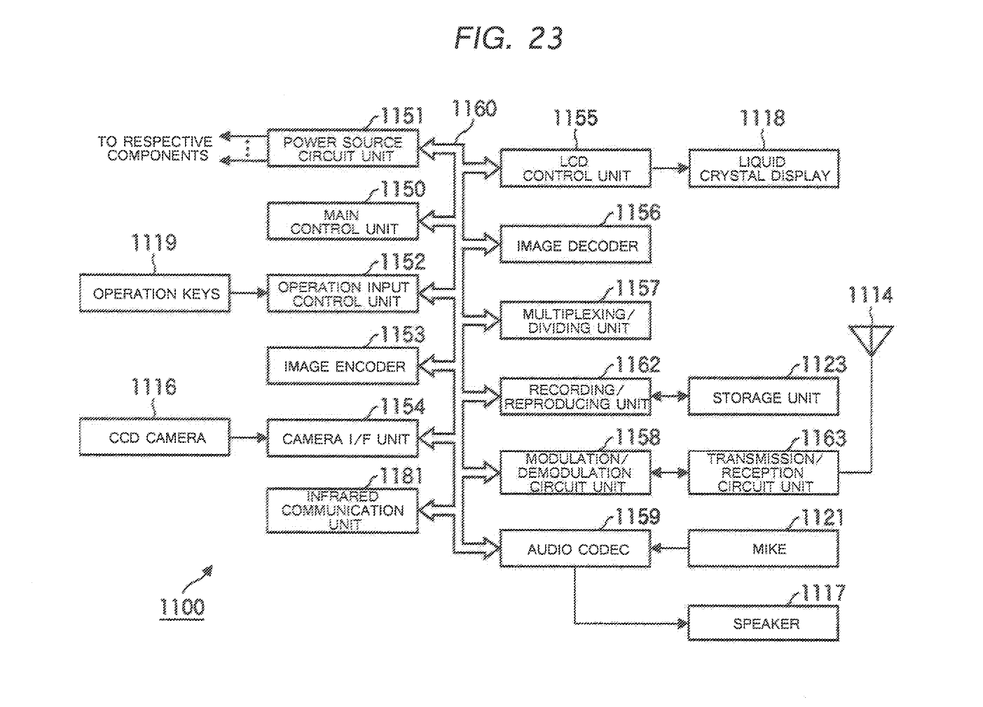

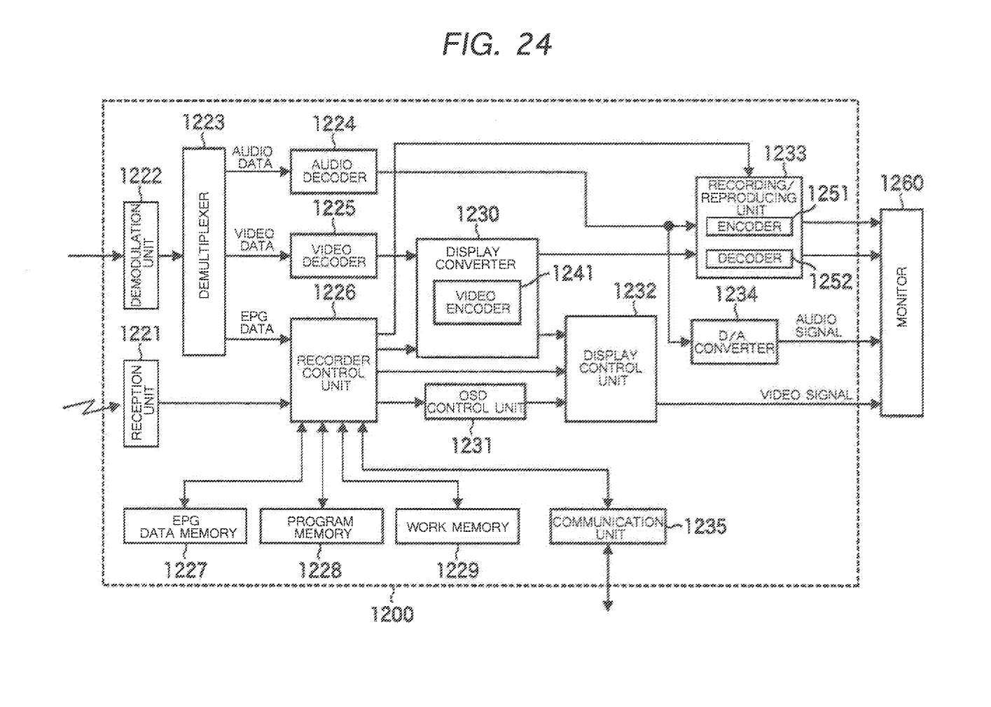

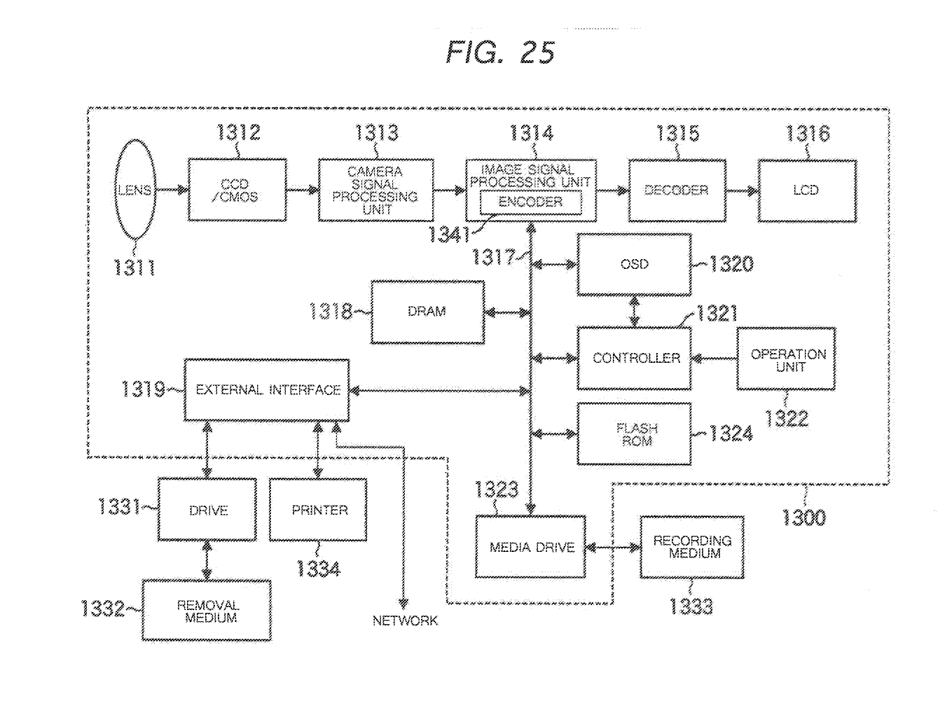

In FIG. 7, “mvcol” represents the motion vector information about the co-located block of the block (or the block having the same xy coordinates as the block in the reference image), and mvtk (k being 0 through 8) represents the motion vector information about the adjacent blocks. The predicted motion vector information (predictors) about the respective blocks is defined as expressed by the following equations (17) through (19)

### Temporal Predictor:

[Equation 14]

mvₜₘ₅=median{mv_{col},mvₜ₀, . . . ,mvₜ₃} (17)

[Equation 15]

mvₜₘ₉=median{mv_{col},mvₜₕ} (18)

### Spatio-Temporal Predictor:

[Equation 16]

mvₛₚₜ=median{mv_{col},mv_{col},mvₐ,mv_{b},mv_{c}} (19)

In the image coding apparatus 100, the cost function in a case where the predicted motion vector information about each block is used is calculated for each block, and the optimum predicted motion vector information is selected. In the image compression information, a flag indicating information about which predicted motion vector information is used for the respective blocks is transmitted.

The macroblock size of 16 pixels×16 pixels is not optimal for a large image frame such as UHD (Ultra High Definition: 4000 pixels×2000 pixels), which is a target in the next-generation coding standards. Therefore, Non-Patent Document 2 and others suggest that macroblock sizes should be 64×64 pixels or 32 pixels×32 pixels, as shown in FIG. 8.

That is, according to Non-Patent Document 1, a hierarchical structure is used as shown in FIG. 7, and larger blocks are defined as supersets while the compatibility with macroblocks according to the current AVC is maintained for blocks of 16×16 pixels or smaller.

Non-Patent Document 2 suggests the use of extended macroblocks for inter slices, but Non-Patent Document 3 suggests the use of extended macroblocks for intra slices.

### [Principles of Operation]

In the image coding apparatus 100 illustrated in FIG. 1, the motion vector information in a reference frame needs to be stored in a memory so as to perform a coding operation using the temporal direct mode when a B picture is encoded. If the motion vector coding method disclosed in Non-'Patent Document 1 is also used for a P-picture, the motion vector information also needs to be stored in a memory when the P-picture is encoded. The motion vector information about all the motion compensation blocks needs to be stored in a memory.

Referring now to FIGS. 9 through 11, the principles of operation of this technique, which differs from the above, are described.

By this technique, only the motion vector information 131A about a motion compensation block (or a sub macroblock) 131 (a current small region) located at the uppermost left portion in the current macroblock 130 is stored in the memory, as shown in FIG. 9.

The motion vector information 131A stored in the memory is used as the motion vector information of the reference frame in operations performed for other frames. Therefore, it is also safe to say that the motion vector information of the reference frame is stored in the memory.

By this method, the block 141 that is a sub macroblock of a macroblock in the frame 140 shown in the right portion of FIG. 10 is to be encoded in a direct 8×8 mode that is a temporal direct mode, for example.

In this case, the motion vector information about a co-located block 151 (a small reference region) that exists in a reference frame 150 and corresponds to the block 141 is not stored in the memory, as shown in the left portion of FIG. 10.

The motion vector information of the co-located block 151 is then generated by using adjacent motion vectors stored in the memory.

FIG. 11 is an enlarged view of the macroblock including the co-located block 151 of the reference frame 150 shown in FIG. 10. As described above with reference to FIG. 9, only the motion vector information about the sub macroblock located at the upper left corner of each macroblock is stored. Therefore, in FIG. 11, the motion vector information mv_{A} about the sub macroblock at the upper left corner of the macroblock including the co-located block 151, the motion vector information mv_{B} about the sub macroblock of the macroblock located on the right side of the macroblock, the motion vector information mv_{C} about the sub macroblock of the macroblock that is located under the macroblock, and the motion vector information mv_{D} about the sub macroblock of the macroblock that is located on the right side of the macroblock located under the macroblock (motion vectors 161 through 164 in FIG. 10) are stored in the memory.

On the other hand, the motion vector information mvₓ about the co-located block 151 is not stored in the memory. Therefore, the motion vector information mvₓ about the co-located block 151 in this case is generated by using the motion vector information mv_{A}, mv_{B}, mv_{C}, and mv_{D} stored in the memory.

For example, points A, B, C, and D (the pixels located at the upper left corners of the respective macroblocks) shown in FIG. 11 are set as representative points of the respective macroblocks, and the motion vector information mv_{A}, mv_{B}, mv_{C}, and mv_{D} are used as the motion vector information corresponding to the respective representative points (the points A, B, C, and D). In accordance with the distances from the pixel X at the upper left corner of the co-located block 151 (the representative point of the co-located block 151) to the points A, B, C, and D, the motion vector information mvₓ is generated by an interpolating operation using the motion vector information mv_{A}, mv_{B}, mv_{C}, and mv_{D} stored in the memory.

That is, in the example illustrated in FIG. 11, the motion vector information mvₓ is determined as expressed by the following equation (20):

$$\begin{matrix}[ Equation 17 ] & \\ {mv}_{X} = \frac{{mv}_{A} + {mv}_{B} + {mv}_{C} + {mv}_{D} + 2}{4} & ( 20 )\end{matrix}$$

The motion information about the co-located block 151 can be determined from the adjacent motion vector information stored in the memory. That is, by performing such an operation, the image coding apparatus 100 does not need to store all motion vector information calculated for each motion compensation block (sub macroblock). Accordinglv, increases in the load of the coding operation using the motion vector information correlation in the temporal-axis direction can be restrained, and the circuit size can be made smaller.

The motion vector information mvₓ is calculated by any method, and a method other than the above described one may be used. For example, the motion vector information mv_{A} about the pixel located at the upper left corner of the macroblock including the co-located block 151 may be used as the motion vector information mvₓ, as expressed by the following equation (21)

mvₓ=mv_{A} (21)

The calculation amount required in the operation expressed by the equation (21) is of course smaller, but the coding efficiency achieved in the operation expressed by the equation (20) is higher.

In the above example, the motion vector information about the motion compensation blocks (sub macroblocks) located at the upper left corners of the respective macroblocks is stored in the memory. However, operations are not limited to that, and the motion vector information about motion compensation blocks (sub macroblocks) at other locations such as upper right portions, lower left portions, lower right portions, or center portions may be stored in the memory.

However, there is a possibility that motion compensation blocks (sub macroblocks) at locations other than the upper left portions may vary depending on the method of partitioning (dividing) the macroblock.

Therefore, in a case where the motion vector information about motion compensation blocks (sub macroblocks) at locations other than upper left portions is stored in the memory, it is necessary to store not only the motion vector information but also information indicating what kind of method is used for partitioning the macroblock, so as to determine to which motion compensation block (sub macroblock) the motion vector information stored in the memory corresponds. Therefore, there is a possibility that the amount of information stored in the memory may increase by the amount of the additional information.

On the other hand, the location of the motion compensation partition (sub macroblock) at the uppermost left portion of each macroblock is invariable, regardless of the method of dividing the macroblock. Accordingly, there is no need to store the information about the method of dividing the macroblock, as long as the motion vector information about the motion compensation partition (sub macroblock) at the uppermost left portion is stored as in this technique. Thus, the above problem is solved.

This technique can also be used in the image coding apparatus 100 and an image decoding apparatus 200 that are compatible with macroblocks that are extended as shown in FIG. 8.

Specifically, an extended macroblock may be divided into a large number of sub macroblocks, as in an extended macroblock 170 illustrated in FIG. 12, for example. Accordingly, the memory capacity for storing motion vector information can be greatly reduced by using this technique and storing only the motion vector information of the sub macroblock 171 located at the uppermost left portion as described above.

That is, with extended macroblocks, the effect to reduce the memory capacity by using this technique can be made larger.

### [Temporal Motion Vector Coding Unit]

FIG. 13 is a block diagram showing a specific example structure of the temporal motion vector coding unit 121 shown in FIG. 1.

As shown in FIG. 13, the temporal motion vector coding unit 121 includes a block location determining unit 181, a motion vector interpolation unit 182, and a motion vector buffer 183.

When the mode used for motion vector coding in the temporal direction is a candidate mode at the motion prediction/compensation unit 115, the block address of the motion compensation block is transmitted to the block location determining unit 181.

In a case where the motion vector information about the co-located block is small reference region) that is the motion compensation block having the same address in the reference frame as the block address is stored in the motion vector buffer 183, the block location determining unit 181 transmits the block address to the motion vector buffer 183. The motion vector buffer 183 supplies the motion vector information corresponding to the supplied block address to the motion prediction/compensation unit. 115.

In a case where the motion vector information about the co-located block (the small reference region) is not stored in the motion vector buffer 183, the block location determining unit 181 transmits the block address to the motion vector interpolation unit 182.

The motion vector interpolation unit 162 calculates the addresses of adjacent motion compensation blocks required for the interpolating operation to generate the motion vector information about the motion compensation block at the block address supplied from the block location determining unit 181. The motion vector interpolation unit 182 then supplies the addresses to the motion vector buffer 183. That is, the motion vector interpolation unit 182 supplies the block addresses of the macroblock including the co-located block (the small reference region) in the reference frame and the macroblocks adjacent to the macroblock (the macroblocks adjacent to the macroblock will be hereinafter collectively referred to as the adjacent macroblocks), to the motion vector buffer 183.

The motion vector buffer 183 supplies the motion vector information corresponding to the block addresses of the designated adjacent macroblocks, to the motion vector interpolation unit 182. Using the supplied motion vector information, the motion vector interpolation unit 182 performs an interpolating operation, to generate the target motion vector information corresponding to the co-located block.

The motion vector interpolation unit 182 supplies the generated motion vector information to the motion prediction/compensation unit 115.

That is, upon receipt of a block address from the motion prediction/compensation unit 115, the block location determining unit 181 supplies the block address to the motion vector buffer 183. In a case where the motion vector buffer 183 holds the motion vector information corresponding to the block address, the motion vector buffer 183 reads and supplies the motion vector information to the motion prediction/compensation unit 115.

In a case where no motion vector information corresponds to the block address supplied from the block location determining unit 181, the motion vector buffer 183 notifies the block location determining unit 181 to that effect.

Upon receipt of the notification, the block location determining unit 181 supplies the block address supplied from the motion prediction/compensation unit 115 to the motion vector interpolation unit 182. The motion vector interpolation unit 182 supplies the block addresses of the adjacent macroblocks stored in the motion vector buffer 183 to the motion vector buffer 183.

The motion vector buffer 183 supplies the motion vector information corresponding to the supplied block addresses, to the motion vector interpolation unit 182.

In this manner, the motion vector interpolation unit 182 obtains the adjacent motion vector information required for generating the motion vector information about the co-located block.

Using the obtained motion vector information, the motion vector interpolation unit 182 generates the target motion vector information through an interpolating operation or the like, and supplies the motion vector information to the motion prediction/compensation unit 115.

Using the motion vector information extracted from the motion vector buffer 183 or the motion vector information generated by the motion vector interpolation unit 182, the motion prediction/compensation unit 115 encodes motion vector information with the use of the correlation in the temporal-axis direction as in the conventional temporal direct mod.

For each block, the motion prediction/compensation unit 115 transmits the motion vector information used in the last coding operation to the motion vector buffer 183, and stores the motion vector information into the motion vector buffer 183 for the next coding operation.

With the above mechanism, the image coding apparatus 100 can encode motion vector information with the use of the correlation in the temporal direction simply by storing only the motion vector information about a sub macroblock of each macroblock into the motion vector buffer 183 of the temporal motion vector coding unit 121.

That is, the image coding apparatus 100 can reduce the amount of memory required in coding operations, and reduce the load of coding operations.

### [Flow in Coding Operation]

Next, the flow in each operation to be performed by the above described image coding apparatus 100 is described. Referring first to the flowchart in FIG. 14, an example flow in a coding operation is described.

In step S101, the A/D conversion unit 101 performs an A/D conversion on an input image. In step S102, the picture rearrangement buffer 102 stores the A/D-converted image, and rearranges the image in coding order, instead of picture display order.

In step S103, the calculation unit 103 calculates the difference between the image rearranged through the procedure of step S102 and a predicted image. The predicted image is supplied from the motion prediction/compensation unit 115 to the calculation unit 103 via the select unit 116 in the case of an inter prediction, and is supplied from the intra prediction unit 114 to the calculation unit 103 via the select unit 116 in the case of an intra prediction.

The difference data has a smaller data amount than the original image data. Accordingly, the data amount can be made smaller than in a case where images are encoded as they are.

In step S104, the orthogonal transform unit 104 orthogonally transforms the difference information generated through the procedure of step S103. Specifically, an orthogonal transform such as a discrete cosine transform or a Karhunen-Loeve transform is performed, to output a transform coefficient.

In step S105, the quantization unit 105 quantizes the orthogonal transform coefficient obtained through the procedure of step S104.

The difference information quantized through the procedure of step S105 is locally decoded in the following manner. That is, in step S106, the inverse quantization unit 108 inversely quantizes the quantized orthogonal transform coefficient generated through the procedure of step S105 (also referred to as the quantized coefficient), using characteristics compatible with the characteristics of the quantization unit 105. In step S107, the inverse orthogonal transform unit 109 performs an inverse orthogonal transform on the orthogonal transform coefficient obtained through the procedure of step S106, using characteristics compatible with the characteristics of the orthogonal transform unit 104.

In step S108, the calculation unit 110 adds the predicted image to the locally-decoded difference information, to generate a locally-decoded image (an image equivalent to an input to the calculation unit 103). In step S109, the deblocking filter 111 performs filtering on the image generated through the procedure of step S108. Through this procedure, block distortions are removed.

In step S110, the frame memory 112 stores the image from which block distortions have been removed through the procedure of step S109. The image not subjected to the filtering by the deblocking filter 111 is also supplied to the frame memory 112 from the calculation unit 110, and is stored into the frame memory 112.

In step S111, the intra prediction unit 114 performs an intra predicting operation in intra prediction modes. In step S112, the motion prediction/compensation unit 115 performs an inter motion predicting operation to make motion predictions and motion compensations in inter prediction modes.

In step S113, the select unit 116 selects the optimum prediction mode, based on respective cost function values output from the intra prediction unit 114 and the motion prediction/compensation unit 115. That is, the select unit 116 selects a predicted image generated by the intra prediction unit 114 or a predicted image generated by the motion prediction/compensation unit 115.

Select information indicating which predicted image has been selected is supplied to the intra prediction unit 114 or the motion prediction/compensation unit 115, whichever has generated the selected predicated image. In a case where a predicted image in the optimum intra prediction mode is selected, the intra prediction unit 114 supplies the information indicating the optimum intra prediction mode (or the intra prediction mode information) to the lossless coding unit 106.

In a case where a predicted image in the optimum inter prediction mode is selected, the motion prediction/compensation unit 115 outputs the information indicating the optimum inter prediction mode, and, where necessary, information in accordance with the optimum inter prediction mode, to the lossless coding unit 106. The information in accordance with the optimum inter prediction mode includes motion vector information, flag information, reference frame information, and the like.

In step S114, the lossless coding unit 106 encodes the transform coefficient quantized through the procedure of step S105. That is, lossless coding such as variable-length coding or arithmetic coding is performed on the difference image (a two-dimensional difference image in the case of an inter prediction).

The lossless coding unit 106 encodes a quantization parameter calculated in step S105, and adds the encoded parameter to the encoded data.

The lossless coding unit 106 also encodes the information about the prediction mode of the predicted image selected through the procedure of step S113, and adds the encoded information to the encoded data obtained by encoding the difference image. That is, the lossless coding unit 106 also encodes the intra prediction mode information supplied from the intra prediction unit 114 or the information in accordance with the optimum inter prediction mode supplied from the motion prediction/compensation unit 115, and adds the encoded information to the encoded data.

In step S115, the accumulation buffer 107 accumulates the encoded data output from the lossless coding unit 106. The encoded data accumulated in the accumulation buffer 107 is read out where necessary, and is transmitted to the decoding side via a transmission path.

In step S116, based on the compressed image accumulated in the accumulation buffer 107 through the procedure of step S115, the rate control unit 117 controls the rate of the quantizing operation of the quantization unit 105 so as not to cause overflows and underflows.

When the procedure of step S116 is finished, the coding operation comes to an end.

### [Flow in Inter Motion Predicting Operation]

Referring now to the flowchart in FIG. 15, an example flow in the inter motion predicting operation performed in step S112 of FIG. 14 is described.

When the inter motion prediction operation is started, the motion prediction/compensation unit 115, in step S131, determines motion vectors and a reference image for each inter prediction mode of each block size.

In step S132, the motion prediction/compensation unit 115 performs a compensating operation on the reference image based on the motion vectors for each Inter prediction mode of each block size.

In step S133, the motion prediction/compensation unit 115 calculates a cost function value for each inter prediction mode of each block size.

In step S134, the motion prediction/compensation unit 115 determines the optimum inter prediction mode, based on the cost function values calculated in step S133.

After the optimum inter prediction mode is determined, the motion prediction/compensation unit 115 ends the inter motion predicting operation, and returns the operation to step S112 of FIG. 14. Thereafter, the procedures of step S113 and the following steps are carried out.

In one of such inter prediction modes, the motion prediction/compensation unit 115 causes the temporal motion vector coding unit 121 to perform a temporal motion vector coding operation that is a coding operation using the motion vector information correlation in the temporal-axis direction.

### [Flow in Temporal Motion Vector Coding Operation]

Referring now to the flowchart in FIG. 16, an example flow in the temporal motion vector coding operation is described.

When the temporal motion vector coding operation is started, the block location determining unit 181, in step S151, obtains the address of a current block (a current block address) supplied from the motion prediction/compensation unit 115.

In step S152, the block location determining unit 181 determines whether the motion vector information about the co-'located block that is the motion compensation block (sub macroblock) located at the current block address in the reference frame is stored in the motion vector buffer 183.

In a case where the block location determining unit 181 determines that the motion vector information about the co-located block is stored in the motion vector buffer 183, the motion vector buffer 183, in step S153, reads the motion vector information about the co-located block, and supplies the motion vector information to the motion prediction/compensation unit 115.

In a case where the block location determining unit 181 determines, in step S152, that the motion vector information about the co-located block is not stored in the motion vector buffer 183, the block location determining unit 181 supplies the current block address to the motion vector interpolation unit 182. The motion vector interpolation unit 182 obtains the block addresses of the adjacent macroblocke (including the macroblock including the co-located block, and the macroblocks adjacent to the macroblock) from the supplied current block address, and supplies the obtained block addresses to the motion vector buffer 183.

In step S154, the motion vector buffer 183 reads the motion vector information corresponding to the supplied block addresses of the adjacent macroblocks, and supplies the motion vector information to the motion vector interpolation unit 182.

In step S155, the motion vector interpolation unit 182 performs an interpolating operation, to generate the motion vector information about the co-located block.

In step S156, using the motion vector information supplied from the temporal motion vector coding unit 121 as described above, the motion prediction/compensation unit 115 encodes the motion vector information by using the correlation in the temporal-axis direction.

In step S157, the motion prediction/compensation unit 115 determines whether the motion vector information used in the coding, or the motion vector information about the co-located block, should be stored.

For example, the motion vector information about the motion compensation block (sub macroblock) at the upper left corner of each macroblock is to be stored in the motion vector buffer 183. If the co-located block is a block located at the upper left corner of a macroblock, the motion prediction/compensation unit 115 determines that the motion vector information about the co-located block should be stored.

In this case, the motion prediction/compensation unit 115 moves the operation on to step S158, and supplies the motion vector information to the motion vector buffer 183. The motion vector buffer 183 stores the motion vector information supplied from the motion prediction/compensation unit 115.

After the motion vector information is stored, the temporal motion vector coding unit 121 ends the temporal motion vector coding operation. In a case where the motion prediction/compensation unit 115 determines, in step S157, that the motion vector information about the co-located block is not to be stored, the temporal motion vector coding unit 121 skips the procedure of step S158, and ends the temporal motion vector coding operation.

As described above, by performing the respective operations, the image coding apparatus 100 can reduce the amount of motion vector information to be stored in the motion vector buffer 183, and reduce the load of the coding operation.

### 2. Second. Embodiment

### [Image Decoding Apparatus]

FIG. 17 is a block diagram showing an example principal structure of an image decoding apparatus. The image decoding apparatus 200 illustrated in FIG. 17 is a decoding apparatus compatible with the image coding apparatus 100.

Data encoded by the image coding apparatus 100 is transmitted to the image decoding apparatus 200 compatible with the image coding apparatus 100 via a predetermined transmission path, and is then decoded.

As shown in FIG. 17, the image decoding apparatus 200 includes an accumulation buffer 201, a lossless decoding unit 202, an inverse quantization unit 203, an inverse orthogonal transform unit 204, a calculation unit 205, a deblocking filter 206, a picture rearrangement buffer 207, and a D/A conversion unit 208. The image decoding apparatus 200 also includes a frame memory 209, a select unit 210, an intra prediction unit 211, a motion prediction/compensation unit 212, and a select unit 213.

The image decoding apparatus 200 further includes a temporal motion vector decoding unit 221.

The accumulation buffer 201 accumulates transmitted encoded data. The encoded data has been encoded by the image coding apparatus 100. The lossless decoding unit 202 decodes encoded data read out from the accumulation buffer 201 at a predetermined time, by using a method compatible with the coding method used by the lossless coding unit 106 of FIG. 1.

The inverse quantization unit 203 inversely quantizes coefficient data (a quantization coefficient) decoded and obtained by the lossless decoding unit 202, using a method compatible with the quantization method used by the quantization unit 105 of FIG. 1.

The inverse quantization unit 203 supplies the inversely-quantized coefficient data, or an orthogonal transform coefficient, to the inverse orthogonal transform unit 204. The inverse orthogonal transform unit 204 performs an inverse orthogonal transform on the orthogonal transform coefficient by using a method compatible with the orthogonal transform method used by the orthogonal transform unit 104 of FIG. 1, and obtains decoded residual data corresponding to the residual data not yet subjected to the orthogonal transform in the image coding apparatus 100.

The decoded residual data obtained through the inverse orthogonal transform is supplied to the calculation unit 205. A predicted image is also supplied to the calculation unit 205 from the intra prediction unit 211 or the motion prediction/compensation unit 212 via the select unit 213.

The calculation unit 205 adds the decoded residual data and the predicted image, and obtains decoded image data corresponding to the image data from which a predicted image has not yet been subtracted by the calculation unit 103 in the image coding apparatus 100. The calculation unit 205 supplies the decoded image data to the deblocking filter 206.

The deblocking filter 206 removes block distortions from the supplied decoded image, and supplies the decoded image to the picture rearrangement buffer 207.

The picture rearrangement buffer 207 performs picture rearrangement. That is, the frame order rearranged in the coding order by the picture rearrangement buffer 102 of FIG. 1 is rearranged in the original display order. The D/A conversion unit 208 performs a D/A conversion on the image supplied from the picture rearrangement buffer 207, and outputs the image to a display (not shown) to display the image.

The output from the deblocking filter 206 is also supplied to the frame memory 209.

The frame memory 209, the select unit 210, the litre prediction unit 211, the motion prediction/compensation unit 212, and the select unit 213 are equivalent to the frame memory 112, the select unit 113, the intra prediction unit 114, the motion prediction/compensation unit 115, and the select unit 116 of the image coding apparatus 100.

The select unit 210 reads an image to be subjected to inter processing and an image to be referred to, from the frame memory 209, and supplies the images to the motion prediction/compensation unit 212. The select unit 210 also reads, from the frame memory 209, an image to be used for an intra prediction, and supplies the image to the intra prediction unit 211.

Information indicating an intra prediction mode or the like obtained by decoding header information is supplied to the intra prediction unit 211 from the lossless decoding unit 202 where necessary. Based on the information, the intra prediction unit 211 generates a predicted image from the reference image obtained from the frame memory 209, and supplies the generated predicted image to the select unit 213.

The motion prediction/compensation unit 212 obtains, from the lossless decoding unit 202, information generated by decoding header information (prediction mode information, motion vector information, reference frame information, a flag, various parameters, and the like).

Based on the information supplied from the lossless decoding unit 202, the motion prediction/compensation unit 212 generates a predicted image from the reference image obtained from the frame memory 209, and supplies the generated predicted image to the select unit 213.

In a case where a mode for performing coding by using the motion vector information correlation in the temporal-axis direction, such as a temporal direct mode, is selected in the image coding apparatus 100, the motion prediction/compensation unit 212 performs a motion predicting/compensating operation in the mode by using the temporal motion vector decoding unit 221.

The select unit 213 selects a predicted image generated by the motion prediction/compensation unit 212 or the intra prediction unit 211, and supplies the predicted image to the calculation unit 205.

The temporal motion vector decoding unit 221 has the same structure and performs the same operation as the temporal motion vector coding unit 121 of the image coding apparatus 100. That is, the temporal motion vector decoding unit 221 has the structure illustrated in FIG. 13, and performs the same operation (a temporal motion vector decoding operation) as the temporal motion vector coding operation described with reference to the flowchart in FIG. 16, to generate motion vector information corresponding to the block address supplied from the motion prediction/compensation unit 212 where necessary, and supply the motion vector information to the motion prediction/compensation unit 212.

Therefore, the specific structure of the temporal motion vector decoding unit 221, and the flow in the temporal motion vector decoding operation are not described herein.

### [Flow in Decoding Operation]

Next, the flow in each operation to be performed by the above described, image decoding apparatus 200 is described. Referring first to the flowchart in FIG. 18, an example flow in a decoding operation is described.

When the decoding operation is started, the accumulation buffer 201 accumulates transmitted encoded data in step S201. In step S202, the lossless decoding unit 202 decodes the encoded data supplied from the accumulation buffer 201. That is, an i-picture, a P-picture, and a B-picture, which have been encoded by the lossless coding unit 106 of FIG. 1, are decoded.

At this point, motion vector information, reference frame information, prediction mode information (an intra prediction mode or an inter prediction mode), and information about a flag, quantization parameters, and the like are also decoded.

In a case where the prediction mode information is intra prediction mode information, the prediction mode information is supplied to the intra prediction unit 211. In a case where the prediction mode information is inter prediction mode information, the motion vector information corresponding to the prediction mode information is supplied to the motion prediction/compensation unit 212.

In step S203, the inverse quantization unit 203 inversely quantizes the quantized orthogonal transform coefficient decoded and obtained by the lossless decoding unit 202, using a method compatible with the quantizing operation performed by the quantization unit 105 of FIG. 1. In step S204, the inverse orthogonal transform unit 204 performs an inverse orthogonal transform on the orthogonal transform coefficient obtained through the inverse quantization performed by the inverse quantization unit 203, using a method compatible with the orthogonal transforming operation performed by the orthogonal transform unit 104 of FIG. 1. In this manner, the difference information corresponding to the input to the orthogonal transform unit 104 (or the output from the calculation unit 103) of FIG. 1 is decoded.

In step S205, the calculation unit 205 adds a predicted image to the difference information obtained through the procedure of step S204. In this manner, the original image data is decoded.

In step S206, the deblocking filter 206 performs filtering, where necessary, on the decoded image obtained through the procedure of step S205. In this manner, block distortions are removed from the decoded image where necessary.

In step S207, the frame memory 203 stores the decoded image subjected to the filtering, in step S208, the intra prediction unit 211 or the motion prediction/compensation unit 212 performs an image predicting operation in accordance with the prediction mode information supplied from the lossless decoding unit 202.

That is, in a case where intra prediction mode information is supplied from the lossless decoding unit 202, the intra prediction unit 211 performs an intra predicting operation in the intra prediction mode. In a case where inter prediction mode information is supplied from the lossless decoding unit 202, the motion prediction/compensation unit 212 performs a motion predicting operation in an inter prediction mode.

In step S209, the select unit 213 selects a predicted image. That is, a predicted image generated by the intra prediction unit 211 or a predicted image generated by the motion prediction/compensation unit 212 is supplied to the select unit 213. The select unit 213 selects the supplied predicted image, and supplies the predicted image to the calculation unit 205. The predicted image is added to the difference information in the procedure of step S205.

In step S210, the picture rearrangement buffer 207 rearranges the frames of the decoded image data. That is, in the decoded image data, the frame order rearranged for coding by the picture rearrangement buffer 102 of the image coding apparatus 100 (FIG. 1) is rearranged in the original display order.

In step S211, the D/A conversion unit 208 performs a D/A conversion on the decoded image data having the frames rearranged by the picture rearrangement buffer 207. The decoded image data is output to a display (not shown), and the image is displayed.

### [Flow in Predicting Operation]

Referring now to the flowchart in FIG. 19, a specific example flow in the predicting operation performed in step S208 of FIG. 18 is described.

When the predicting operation is started, the lossless decoding unit 202, in step S231, determines whether the encoded data has been subjected to intra coding, based on the decoded prediction mode information.

In a case where the lossless decoding unit 202 determines that the encoded data has been subjected to intra coding, the lossless decoding unit 202 moves the operation on to step S232.

In step S232, the intra prediction unit 211 obtains, from the lossless decoding unit 282, information such as intra prediction mode information necessary for generating a predicted image. In step S233, the intra prediction unit 211 obtains a reference image from the frame memory 209, and performs an intra predicting operation in an intra prediction mode, to generate a predicted image.

After generating the predicted image, the intra prediction unit 211 supplies the generated predicted image to the calculation unit 205 via the select unit 213, and ends the predicting operation. The operation then returns to step S208 of FIG. 18, and the procedures of step S209 and the following procedures are carried out.

In a case where the lossless decoding unit 202 determines, in step S231 of FIG. 19, that the encoded data has been subjected to inter coding, the lossless decoding unit 202 moves the operation on to step S234.

In step S234, the motion prediction/compensation unit 212 obtains, from the lossless decoding unit 282, information necessary for generating a predicted image, such as motion prediction mode information, reference frame information, and difference motion vector information.

In step S235, the motion prediction/compensation unit 212 decodes motion vector information in the designated mode. In a case where a mode for performing coding by using the motion vector information correlation in the temporal-axis direction, such as a temporal direct mode, is selected in the image coding apparatus 100, the motion prediction/compensation unit 212 causes the temporal motion vector decoding unit 221 to provide desired motion vector information, and performs a decoding operation using the correlation in the temporal-axis direction by using the motion vector information. In this manner, the difference motion vector information is decoded.

In step S236, the motion prediction/compensation unit 212 generates a predicted image from the reference image, using the decoded motion vector information.

After generating the predicted image, the motion prediction/compensation unit 212 supplies the generated predicted image to the calculation unit 205 via the select unit 213, and ends the predicting operation. The operation then returns to step S203 of FIG. 18, and the procedures of step S209 and the following procedures are carried out.

By performing the decoding operation and the predicting operation as described above, the image decoding apparatus 200 can reduce the amount of motion vector information to be stored in the motion vector buffer of the temporal motion vector decoding unit 221, and reduce the load of the motion vector information decoding operation using the correlation in the temporal direction, as in the case of the image coding apparatus 100.

That is, the image decoding apparatus 200 can decode motion vector information with the use of the correlation in the temporal direction simply by storing only the motion vector information about a sub macroblock of each macroblock into the motion vector buffer of the temporal motion vector decoding unit 221.

In the above description, when the motion vector information about a co-located block is calculated, weighting in accordance with distances is performed on the adjacent motion vector information by an interpolating operation. However, the weighting to be performed on the adjacent motion vector information is not limited to that, and may be performed based on any kind of information. For example, the weighting may be performed based on any characteristics, such as the block sizes of the motion compensation blocks (sub macroblocks) corresponding to respective pieces of motion vector information, the complexities (the types of texture) of the images in blocks, or the pixel distribution similarities in blocks.

The pixels at the upper left portions of respective blocks are the representative blocks in the above description, but the representative blocks may be located in some other positions.

In the above description, the motion vector buffers of the temporal motion vector coding unit 121 and the temporal motion vector decoding unit 221 hold motion vectors. However, each one macroblock may hold more than one motion vector.

For example, as in a macroblock 300 shown in FIG. 20, the motion vector information (motion vector information 301A through 304A) about the sub macroblocks at the four corners (sub macroblocks 301 through 304) may be stored in the motion vector buffers.

As the motion vector information is stored in this manner, the motion vector information about a sub macroblock in the macroblock 300 (the motion vector information 311A about a sub macroblock 311, for example) may be determined by performing an interpolating operation using the motion vector information 301A through 304A.

With this arrangement, there is no need to refer to any other macroblock, and only the macroblock including the co-located block should be referred to. Accordingly, reading motion vector information from the motion vector buffers becomes easier.

For example, motion vector information is not combined with the motion vector information about another macroblock, and therefore, can be collectively compressed for each macroblock and be stored in the motion vector buffers. In the example illustrated in FIG. 20, the motion vector information 301A through 304A belonging to the macroblock 300 can be collectively encoded.

In a case where an interpolating operation is performed on a combination of the motion vector information about two or more macroblocks as described in the first embodiment, unnecessary motion vector information needs to be read out if the motion vector information is collectively encoded for each macroblock in the above manner. This results in a poorer efficiency. In a case where an interpolating operation is performed only on the motion vector information about the macroblock, on the other hand, the motion vector information about the macroblock can be collectively read out, and efficient reading can be performed.

Further, motion vector information is stored after coding. Accordingly, a reduced amount of motion vector information can be stored, and the storage areas of the motion vector buffers can be more efficiently used.

It goes without saying that the number of pieces of motion vector information per macroblock to be stored in the motion vector buffers may not be four, and the motion vector information of any motion compensation blocks (sub macroblocks) may be stored.

In the above description, an image coding apparatus that performs coding by using a method compliant with AVC, and an image decoding apparatus that performs decoding by using a method compliant with AVC have been described as examples. However, the range of applications of this technique is not limited to them, and this technique can be used in any image coding apparatuses and any image decoding apparatuses that perform coding operations based on blocks having hierarchical structures as shown in FIG. 8.

### 3. Third Embodiment

### [Personal Computer]

The above described series of operations can be performed by hardware or software. In this case, a personal computer shown in FIG. 21 may be formed, for example.

In FIG. 21, the CPU (Central Processing Unit) 501 of the personal computer 500 performs various kinds of operations in accordance with a program stored in a ROM (Read Only Memory) 502 or a program loaded into a RAM (Random Access Memory) 503 from a storage unit 513. The data necessary for the CPU 501 to perform various kinds of operations is also stored in the RAM 503 where necessary.

The CPU 501, the ROM 502, and the RAM 503 are connected to one another via a bus 504. An input/output interface 510 is also connected to the bus 504.

An input unit 511 formed with a keyboard, a mouse, and the like, an output unit 512 formed with a display formed with a CRT (Cathode Ray Tube), an LCD (Liquid Crystal Display), or the like, and a speaker or the like the storage unit 513 formed with a hard disk or the like, and a communication unit 514 formed with a modem or the like are connected to the input/output interface 510. The communication unit 514 performs communicating operations via networks including the internet.

A drive 515 is also connected to the input/output interface 510 where necessary, and a removable medium 521 such as a magnetic disk, an optical disk, a magneto-optical disk, a semiconductor memory, or the like is mounted on the drive 515 where appropriate. A computer program read out from those media is installed in the storage unit 513 where necessary.

In a case where the above described series of operations are performed by software, a program to form the software is installed from a network or a recording medium.

This recording medium may be distributed to deliver the program to users, separately from the apparatus, as shown in FIG. 21. For example, this recording medium may be formed with the removable medium 521, such as a magnetic disk (or a flexible disk) having the program recorded thereon, an optical disk (or a CD-ROM (Compact Disc-Read Only Memory or a DVD (Digital Versatile Disc)), a magneto-optical disk or a MD (Mini Disc)), or a semiconductor memory. Alternatively, this recording medium may be formed with the ROM 502 having the program recorded thereon, or a hard disk contained in the storage unit 513, or the like. The ROM 502 and the hard disk are incorporated into the apparatus beforehand, and are distributed to users.

The program to be executed by the computer may be a program for performing operations in chronological order in accordance with the sequences described in this specification, or may be a program for performing operations in parallel or at a time when there is a call or the like.

In this specification, the step of writing a program to be recorded on a recording medium includes not only operations to be performed in chronological order in accordance with the disclosed sequences, but also operations to be performed in parallel or independently of one another if not in chronological order.

In this specification, a “system” means an entire apparatus formed with two or more devices (apparatuses).

In the above description, any structure described as one apparatus (or one processing unit) may be divided and formed as two or more apparatuses (or processing units). Any structure described as two or more apparatuses (or processing units) may be formed as one apparatus (or one processing unit). A structure that has not been described above may be of course added to the structure of each apparatus (or each processing unit). Further, as long as the structure and operations of the entire system will not substantially change, part of the structure of an apparatus or a processing unit) may be incorporated into the structure of another apparatus (or another processing unit). That is, embodiments of this technique are not limited to the above described embodiments, and various modifications may be made to them without departing from the scope of this technique.

For example, the above described image coding its apparatus and the above described image decoding apparatus can be applied to any electronic apparatuses. In the following, examples of such applications will be described.

### 4. Fourth Embodiment

### [Television Receiver]

FIG. 22 is a block diagram showing an example principal structure of a television receiver using the image decoding apparatus 200.

The television receiver 1000 shown in FIG. 22 includes a terrestrial tuner 1013, a video decoder 1015, a video signal processor circuit 1018, a graphic generator circuit 1019, a panel driver circuit 1020, and a display panel 1021.

The terrestrial tuner 1013 receives a broadcast wave signal of analog terrestrial broadcasting via an antenna, demodulates the signal to obtain a video signal. The terrestrial tuner 1013 supplies the video signal to the video decoder 1015. The video decoder 1015 performs a decoding operation on the video signal supplied from the terrestrial tuner 1013, and supplies the resultant digital component signal to the video signal processor circuit 1018.

The video signal processor circuit 1018 performs predetermined processing such as denoising on the video data supplied from the video decoder 1015, and supplies the resultant video data to the graphic generator circuit 1019.

The graphic generator circuit 1019 generates video data of a show to be displayed on the display panel 1021, or image data by performing an operation based on an application supplied via a network. The graphic generator circuit 1019 supplies the generated video data or the image data to the panel driver circuit 1020. The graphic generator circuit 1019 also generates video data (a graphic) for displaying a screen to be used by a user to select an item, and superimposes the video data on the video data of the show. The resultant video data is supplied to the panel driver circuit 1020 where appropriate.

Based on the data supplied from the graphic generator circuit 1019, the panel driver circuit 1020 drives the display panel 1021, and causes the display panel 1021 to display the video image of the show and each screen described above.

The display panel 1021 is formed with an LCD (Liquid Crystal Display) or the like, and displays the video image of a show or the like under the control of the panel driver circuit 1020.

The television receiver 1000 also includes an audio A/D (Analog/Digital) converter circuit 1014, an audio signal processor circuit 1022, an echo canceller/audio synthesizer circuit 1023, an audio amplifier circuit 1024, and a speaker 1025.

The terrestrial tuner 1013 obtains not only a video signal but also an audio signal by demodulating a received broadcast wave signal. The terrestrial tuner 1013 supplies the obtained audio signal to the audio A/D converter circuit 1014.

The audio A/D converter circuit 1014 performs an A/D converting operation on the audio signal supplied from the terrestrial tuner 1013, and supplies the resultant digital audio signal to the audio signal processor circuit 1022.

The audio signal processor circuit 1022 performs predetermined processing such as denoising on the audio data supplied from the audio A/D converter circuit 1014, and supplies the resultant audio data to the echo canceller/audio synthesizer circuit 1023.

The echo canceller/audio synthesizer circuit 1023 supplies the audio data supplied from the audio signal processor circuit 1022 to the audio amplifier circuit 1024.

The audio amplifier circuit 1024 performs a D/A converting operation and an amplifying operation on the audio data supplied from the echo canceller/audio synthesizer circuit 1023. After adjusted to a predetermined sound volume, the sound is output from the speaker 1025.

The television receiver 1000 further includes a digital tuner 1016 and a MPEG decoder 1017.

The digital tuner 1016 receives a broadcast wave signal of digital broadcasting (digital terrestrial broadcasting or digital BS (Broadcasting Satellite)/CS (Communications Satellite) broadcasting) via the antenna, and demodulates the broadcast wave signal, to obtain a MPEG-TS (Moving Picture Experts Group-Transport Stream) The MPEG-TS is supplied to the MPEG decoder 1017.

The MPEG decoder 1017 descrambles the MPEG-TS supplied from the digital tuner 1016, and extracts the stream containing the data of the show to be reproduced (to be viewed). The MPEG decoder 1017 decodes the audio packet forming the extracted stream, and supplies the resultant audio data to the audio signal processor circuit 1022. The MPEG decoder 1017 also decodes the video packet forming the stream, and supplies the resultant video data to the video signal processor circuit 1018. The MPEG decoder 1017 also supplies EPG (Electronic Program Guide) data extracted from the MPEG-TS to a CPU 1032 via a path (not shown).

The television receiver 1000 uses the image decoding apparatus 200 as the MPEG decoder 1017, which decodes the video packet as described above. The MPEG-TS transmitted from a broadcast station or the like has been encoded by the image coding apparatus 100.

When performing a motion vector information decoding operation using the correlation in the temporal direction as in the case of the image decoding apparatus 200, the MPEG decoder 1017 stores only the motion vector information about a sub macroblock of each macroblock into the motion vector buffer of the temporal motion vector decoding unit 221, and calculates the motion vector information about the other sub macroblocks by performing an interpolating operation or the like using other motion vector information stored in the motion vector buffer. Accordingly, the MPEG decoder 1017 can reduce the amount of motion vector information to be stored in the motion vector buffer, and can reduce the load of the motion vector information decoding operation using the correlation in the temporal direction.

The video data supplied from the MPEG decoder 1017 is subjected to predetermined processing at the video signal processor circuit 1018, as in the case of the video data supplied from the video decoder 1015. At the graphic generator circuit 1019, generated video data and the like are superimposed on the video data where appropriate. The resultant video data is supplied to the display panel 1021 via the panel driver circuit 1020, and the image is displayed.

The audio data supplied from the MPEG decoder 1017 is subjected to predetermined processing at the audio signal processor circuit 1022, as in the case of the audio data supplied from the audio A/D converter circuit 1014. The resultant audio data is supplied to the audio amplifier circuit 1024 via the echo canceller/audio synthesizer circuit 1023, and is subjected to a D/A converting operation or an amplifying operation. As a result, a sound that is adjusted to a predetermined sound volume is output from the speaker 1025.

The television receiver 1000 also includes a microphone 1026 and an A/D converter circuit 1027.

The A/D converter circuit 1027 receives a signal of a user's voice captured by the microphone 1026 provided for voice conversations in the television receiver 1000. The A/D converter circuit 1027 performs an A/D converting operation on the received audio signal, and supplies the resultant digital audio data to the echo canceller/audio synthesizer circuit 1023.

In a case where audio data of a user (a user A) of the television receiver 1000 is supplied from the A/D converter circuit 1027, the echo canceller/audio synthesizer circuit 1023 performs echo cancelling on the audio data of the user A, and combines the audio data with other audio data or the like. The resultant audio data is output from the speaker 1025 via the audio amplifier circuit 1024.

The television receiver 1000 further includes an audio codec 1028, an internal bus 1029, a SDRAM (Synchronous Dynamic Random Access Memory) 1030, a flash memory 1031, the CPU 1032, a USB (Universal Serial Bus) I/F 1033, and a network I/F 1034.

The A/D converter circuit 1027 receives the signal of the user's voice captured by the microphone 1026 provided for voice conversations in the television receiver 1000. The A/D converter circuit 1027 performs an A/D converting operation on the received audio signal, and supplies the resultant digital audio data to the audio codec 1028.

The audio codec 1028 transforms the audio data supplied from the A/D converter circuit 1027 into data in a predetermined format for transmission via a network, and supplies the result to the network I/F 1034 via the internal bus 1029.

The network I/F 1034 is connected to a network via a cable attached to a network terminal 1035. The network I/F 1034 transmits the audio data supplied from the audio codec 1028 to another apparatus connected to the network, for example. The network I/F 1034 also receives, via the network terminal 1035, audio data transmitted from another apparatus connected to the network, and supplies the audio data to the audio codec 1028 via the internal bus 1029.

The audio codec 1028 transforms the audio data supplied from the network I/F 1034 into data in a predetermined format, and supplies the result to the echo canceller/audio synthesizer circuit 1023.

The echo canceller/audio synthesizer circuit 1023 performs echo cancelling on the audio data supplied from the audio codec 1028, and combines the audio data with other audio data or the like. The resultant audio data is output from the speaker 1025 via the audio amplifier circuit 1024.

The SCRAM 1030 stores various kinds of data necessary for the CPU 1032 to perform processing.

The flash memory 1031 stores the program to be executed by the CPU 1032.

The program stored in the flash memory 1031 is read by the CPU 1032 at a predetermined time, such as when the television receiver 1000 is activated. The flash memory 1031 also stores EPG data obtained through digital broadcasting, data obtained from a predetermined server via a network, and the like.

For example, the flash memory 1031 stores a MPEG-TS containing content data obtained from a predetermined server via a network, under the control of the CPU 1032. The flash memory 1031 supplies the MPEG-TS to the MPEG decoder 1017 via the internal bus 1029, under the control of the CPU 1032, for example.

The MPEG decoder 1017 processes the MPEG-TS, as in the case of the MPEG-TS supplied from the digital tuner 1016. In this manner, the television receiver 1000 receives the content data formed with a video image and a sound via the network, and decodes the content data by using the MPEG decoder 1017, to display the video image and output the sound.

The television receiver 1000 also includes a light receiving unit 1037 that receives an infrared signal transmitted from a remote controller 1051.

The light receiving unit 1037 receives an infrared ray from the remote controller 1051, and outputs a control code indicating the contents of a user operation obtained through decoding, to the CPU 1032.

The CPU 1032 executes the program stored in the flash memory 1031, and controls the entire operation of the television receiver 1000 in accordance with the control code and the like supplied from the light receiving unit 1037. The respective components of the television receiver 1000 are connected to the CPU 1032 via paths (not shown).

The USB I/F 1033 exchanges data with an apparatus that is located outside the television receiver 1000 and is connected to the television receiver 1000 via a USB cable attached to a USB terminal 1036. The network I/F 1034 is connected to the network via the cable attached to the network terminal 1035, and also exchanges data other than audio data with any kinds of apparatuses connected to the network.

In a case where broadcast wave signals received via an antenna and content data obtained via a network are encoded in a mode for performing a motion vector information coding operation using the correlation in the temporal direction, the television receiver 1000 can reduce the amount of memory required in the decoding operation and reduce the load, by using the image decoding apparatus 200 as the MPEG decoder 1017.

### 5. Fifth Embodiment

### [Portable Telephone]

FIG. 23 is a block diagram showing an example principal structure of a portable telephone using the image coding apparatus 100 and the image decoding apparatus 200.

The portable telephone 1100 shown in FIG. 16 includes a main control unit 1150 designed to collectively control respective components, a power source circuit unit 1151, an operation input control unit 1152, an image encoder 1153, a camera I/F unit 1154, an LCD control unit 1155, an image decoder 1156, a multiplexing/dividing unit 1157, a recording/reproducing unit 1162, a modulation/demodulation circuit unit 1158, and an audio codec 1159. Those components are connected to one another via a bus 1160.

The portable telephone 1100 also includes operation keys 1119, a CUD (Charge Coupled. Device) camera 1116, a liquid crystal display 1118, a storage unit 1123, a transmission/reception circuit unit 1163, an antenna 1114, a microphone (mike) 1121, and a speaker 1117.

When a call is ended or the power key is switched on by a user's operation, the power source circuit unit 1151 puts the portable telephone 1100 into an operable state by supplying power from a battery back to the respective components.

Under the control of the main control unit 1150 formed with a CPU, a ROM, a RAM, and the like, the portable telephone 1100 performs various operations, such as transmission and reception of audio signals, transmission and reception of electronic mail and image data, image capturing, and data recording, in various modes such as a voice communication mode and a data communication mode.

In the portable telephone 1100 in the voice communication mode, for example, an audio signal captured by the microphone (mike) 1121 is transformed into digital audio data by the audio codec 1159, and the digital audio data is subjected to spread spectrum processing at the modulation/demodulation circuit unit 1158. The resultant data is then subjected to a digital-analog conversion and a frequency conversion at the transmission/reception circuit unit 1163. The portable telephone 1100 transmits the transmission signal obtained through the converting operations to a base station (not shown) via the antenna 1114. The transmission signal (audio signal) transmitted to the base station is supplied to the portable telephone of the other end of the communication via a public telephone line network.

In the portable telephone 1100 in the voice communication mode, for example, a reception signal received by the antenna 1114 is amplified at the transmission/reception circuit unit 1163, and is further subjected to a frequency conversion and an analog-digital conversion. The resultant signal is subjected to inverse spread spectrum processing at the modulation/demodulation circuit unit 1158, and is transformed into an analog audio signal by the audio codec 1159. The portable telephone 1100 outputs the transformed analog audio signal from the speaker 1117.

Further, in a case where electronic mail is transmitted in the data communication mode, for example, the operation input control unit 1152 of the portable telephone 1100 receives text data of the electronic mail that is input by operating the operation keys 1119. The portable telephone 1100 processes the text data at the main control unit 1150, and displays the text data as an image on the liquid crystal display 1118 via the LCD control unit 1155.

In the portable telephone 1100, the main control unit 1150 generates electronic mail data, based on text data, a user's instruction, or the like received by the operation input control unit 1152. The portable telephone 1100 subjects the electronic mail data to spread spectrum processing at the modulation/demodulation circuit unit 1158, and to a digital-analog conversion and a frequency conversion at the transmission/reception circuit unit 1163.

The portable telephone 1100 transmits the transmission signal obtained through the converting operations to a base station (not shown) via the antenna 1114. The transmission signal (electronic mail) transmitted to the base station is supplied to a predetermined address via a network, a mail server, and the like.

In a case where electronic mail is received in the data communication mode, for example, the transmission/reception circuit unit 1163 of the portable telephone 1100 receives a signal transmitted from a base station via, the antenna 1114, and the signal is amplified and is further subjected to a frequency conversion and an analog-digital conversion. The portable telephone 1100 subjects the reception signal to inverse spread spectrum processing at the modulation/demodulation circuit unit 1158, to restore the original electronic mail data. The portable telephone 1100 displays the restored electronic mail data on the liquid crystal display 1118 via the LCD control unit 1155.

The portable telephone 1100 can also record (store) the received electronic mail data into the storage unit 1123 via the recording/reproducing unit 1162.

The storage unit 1123 is a rewritable storage medium. The storage unit 1123 may be a semiconductor memory such as a RAM or an internal flash memory, a hard disk, or a removable medium such as a magnetic disk, a magneto-optical disk, an optical disk, a USB memory, or a memory card. It is of course possible to use a memory other than the above.

In a case where image data is transmitted in the data communication mode, for example, the portable telephone 1100 generates the image data at the CCD camera 1116 capturing an image. The CCD camera 1116 includes optical devices such as a lens and a diaphragm, and a CCD as a photoelectric conversion element. The CCD camera 1116 captures an image of an object, converts the intensity of received light into an electrical signal, and generates image data of the image of the object. The CCD camera 1116 encodes the image data at the image encoder 1153 via the camera I/F unit 1154, to obtain encoded image data.

The portable telephone 1100 uses the above described image coding apparatus 100 as the image encoder 1153 performing such an operation. When performing a motion vector information coding operation using the correlation in the temporal direction as in the case of the image coding apparatus 100, the image encoder 1153 stores only the motion vector information about a sub macroblock of each macroblock into the motion vector buffer 183 of the temporal motion vector coding unit 121, and calculates the motion vector information about the other sub macroblocks by performing an interpolating operation or the like using other motion vector information stored in the motion vector buffer 183. Accordingly, the image encoder 1153 can reduce the amount of motion vector information to be stored in the motion vector buffer 183, and reduce the load of the motion vector information coding operation using the correlation in the temporal direction.

At the same time as above, in the portable telephone 1100, the sound captured by the microphone (mike) 1121 during the image capturing by the CCD camera 1116 is analog-digital converted at the audio codec 1159, and is further encoded.

The multiplexing/dividing unit 1157 of the portable telephone 1100 multiplexes the encoded image data supplied from the image encoder 1153 and the digital audio data supplied from the audio codec 1159 by a predetermined technique. The portable telephone 1100 subjects the resultant multiplexed data to spread spectrum processing at the modulation/demodulation circuit unit 1158, and to a digital-analog conversion and a frequency conversion at the transmission/reception circuit unit 1163. The portable telephone 1100 transmits the transmission signal obtained through the converting operations to a base station (not shown) via the antenna 1114. The transmission signal (image data) transmitted to the base station is supplied to the other end of the communication via a network or the like.

In a case where the image data is not transmitted, the portable telephone 1100 can also display the image data generated at the CCD camera 1116 on the liquid crystal display 1118 via the LCD control unit 1155, instead of the image encoder 1153.

In a case where the data of a moving image file linked to a simplified homepage or the like in the data communication mode, the transmission/reception circuit unit 1163 of the portable telephone 1100 receives a signal transmitted from a base station via the antenna 1114. The signal is amplified, and is further subjected to a frequency conversion and an analog-digital conversion. The portable telephone 1100 subjects the reception signal to inverse spread spectrum processing at the modulation/demodulation circuit unit 1158, to restore the original multiplexed data. The portable telephone 1100 divides the multiplexed data into encoded image data and audio data at the multiplexing/dividing unit 1157.

By decoding the encoded image data at the image decoder 1156, the portable telephone 1100 generates reproduction moving image data, and displays the reproduction moving image data on the liquid crystal display 1118 via the LCD control unit 1155. In this manner, the moving image data contained in a moving image file linked to a simplified homepage, for example, is displayed on the liquid crystal display 1118.

The portable telephone 1100 uses the above described image decoding apparatus 200 as the image decoder 1156 performing such an operation. That is, when performing a motion vector information decoding operation using the correlation in the temporal direction as in the case of the image decoding apparatus 200, the image decoder 1156 stores only the motion vector information about a sub macroblock of each macroblock into the motion vector buffer of the temporal motion vector decoding unit 221, and calculates the motion vector information about the other sub macroblocks by performing an interpolating operation or the like using other motion vector information stored in the motion vector buffer. Accordingly, the image decoder 1156 can reduce the amount of motion vector information to be stored in the motion vector buffer, and reduce the load of the motion vector information decoding operation using the correlation in the temporal direction.

At the same time as above, the portable telephone 1100 transforms the digital audio data into an analog audio signal at the audio codec 1159, and outputs the analog audio signal from the speaker 1117.

In this manner, the audio data contained in a moving image file linked to a simplified homepage, for example, is reproduced.

As in the case of electronic mail, the portable telephone 1100 can also record (store) received data linked to a simplified homepage or the like into the storage unit 1123 via the recording/reproducing unit 1162.

The main control unit 1150 of the portable telephone 1100 can also analyze a two-dimensional code obtained by the CCD camera 1116 performing image capturing, to obtain information recorded in the two-dimensional code.

Further, an infrared communication unit 1181 of the portable telephone 1100 can communicate with an external apparatus by using infrared rays.

In a case where image data generated by the CCD camera 1116, for example, is encoded in a mode for performing a motion vector information coding operation using the correlation in the temporal direction prior to transmission, the portable telephone 1100 can reduce the amount of memory required in the coding operation, and reduce the load, by using the image coding apparatus 100 as the image encoder 1153.

Also, in a case where the data (encoded data) of a moving image file linked to a simplified homepage, for example, is encoded in a mode for performing a motion vector information coding operation using the correlation in the temporal direction, the portable telephone 1100 can reduce the amount of memory required in the decoding operation, and reduce the load, by using the image decoding apparatus 200 as the image decoder 1156.

In the above description, the portable telephone 1100 uses the CCD camera 1116. However, instead of the CCD camera 1116, an image sensor using a CMOS (Complementary Metal Oxide Semiconductor) (a CMOS image sensor) may be used. In that case, the portable telephone 1100 can also capture an image of an object, and generate the image data of the image of the object, as in the case where the CCD camera 1116 is used.

Although the portable telephone 1100 has been described above, the image coding apparatus 100 and the image decoding apparatus 200 can also be applied to any apparatus in the same manner as in the case of the portable telephone 1100, as long as the apparatus has the same image capturing function and the same communication function as the portable telephone 1100. Such an apparatus may be a FDA (Personal Digital Assistant), a smartphone, a UMPC (Ultra Mobile Personal Computer), a netbook, or a notebook personal computer, for example.

### 6. Sixth Embodiment

### [Hard Disk Recorder]

FIG. 24 is a block diagram showing an example principal structure of a hard disk recorder using the image coding apparatus 100 and the image decoding apparatus 200.

The hard disk recorder (HDD recorder) 1200 shown in FIG. 24 is an apparatus that stores, into an internal hard disk, the audio data and the video data of a broadcast show contained in a broadcast wave signal (a television signal) that is transmitted from a satellite or a terrestrial antenna or the like and is received by a tuner, and provides the stored data to a user at a time designated by an instruction from the user.

The hard disk recorder 1200 can extract audio data and video data from a broadcast wave signal, for example, decode those data where appropriate, and store the data into an internal and disk. Also, the hard disk recorder 1200 can obtain audio data and video data from another apparatus via a network, for example, decode those data where appropriate, and store the data into an internal hard disk.

Further, the hard disk recorder 1200 can decode audio data and video data recorded on an internal hard disk, for example, supply those data to a monitor 1260, display the image on the screen of the monitor 1260, and output the sound from the speaker of the monitor 1260. Also, the hard disk recorder 1200 can decode audio data and video data extracted from a broadcast wave signal obtained via a tuner, or audio data and video data obtained from another apparatus via a network, for example, supply those data to the monitor 1260, display the image on the screen of the monitor 1260, and output the sound from the speaker of the monitor 1260.

The hard disk recorder 1200 can of course perform operations other than the above.

As shown in FIG. 17, the hard disk recorder 1200 includes a reception unit 1221, a demodulation unit 1222, a demultiplexer 1223, an audio decoder 1224, a video decoder 1225, and a recorder control unit 1226. The hard disk recorder 1200 further includes an EPG data memory 1227, a program memory 1228, a work memory 1229, a display converter 1230, an OSD (On-Screen Display) control unit 1231, a display control unit 1232, a recording/reproducing unit 1233, a D/A converter 1234, and a communication unit 1235.

The display converter 1230 includes a video encoder 1241. The recording/reproducing unit 1233 includes an encoder 1251 and a decoder 1252.

The reception unit 1221 receives an infrared signal from a remote controller (not shown), converts the infrared signal into an electrical signal, and outputs the electrical signal to the recorder control unit 1226. The recorder control unit 1226 is formed with a microprocessor, for example, and performs various kinds of operations in accordance with a program stored in the program memory 1228. At this point, the recorder control unit 1226 uses the work memory 1229 where necessary.

The communication unit 1235 is connected to a network, and performs a communication operation with another apparatus via the network. For example, under the control of the recorder control unit 1226, the communication unit 1235 communicates with a tuner (not shown), and outputs a station select control signal mainly to the tuner.

The demodulation unit 1222 demodulates a signal supplied from the tuner, and outputs the signal to the demultiplexer 1223. The demultiplexer 1223 divides the data supplied from the demodulation unit 1222, into audio data, video data, and EPG data. The demodulation unit 1222 outputs the audio data, the video data, and the EPG data to the audio decoder 1224, the video decoder 1225, and the recorder control unit 1226, respectively.

The audio decoder 1224 decodes the input audio data, and outputs the decoded audio data to the recording/reproducing unit 1233. The video decoder 1225 decodes the input video data, and outputs the decoded video data to the display converter 1230. The recorder control unit 1226 supplies and stores the input EPG data into the EPG data memory 1227.

The display converter 1230 encodes video data supplied from the video decoder 1225 or the recorder control unit 1226 into video data compliant with the NTSC (National Television Standards Committee) standards, for example, using the video encoder 1241. The encoded video data is output to the recording/reproducing unit 1233. Also, the display converter 1230 converts the picture size of video data supplied from the video decoder 1225 or the recorder control unit 1226 into a size compatible with the size of the monitor 1260. The video encoder 1241 converts the video data into video data compliant with the NTSC standards. The NTSC video data is converted into an analog signal, and is output to the display control unit 1232.

Under the control of the recorder control unit 1226, the display control unit 1232 superimposes an OSD signal output from the OSD (On-Screen Display) control unit 1231 on the video signal input from the display converter 1230, and outputs the resultant signal to the display of the monitor 1260 to display the image.

Audio data that is output from the audio decoder 1224 and is converted into an analog signal by the D/A converter 1234 is also supplied to the monitor 1260. The monitor 1260 outputs the audio signal from an internal speaker.

The recording/reproducing unit 1233 includes a hard disk as a storage medium for recording video data, audio data, and the like.

The recording/reproducing unit 1233 causes the encoder 1251 to encode audio data supplied from the audio decoder 1224, for example. The recording/reproducing unit 1233 also causes the encoder 1251 to encode video data supplied from the video encoder 1241 of the display converter 1230. The recording/reproducing unit 1233 combines the encoded data of the audio data with the encoded data of the video data, using a multiplexer. The recording/reproducing unit 1233 amplifies the combined data through channel coding, and writes the resultant data on the hard disk via a recording head.

The recording/reproducing unit 1233 reproduces data recorded on the hard disk via a reproduction head, amplifies the data, and divides the data into audio data and video data by using a demultiplexer.

The recording/reproducing unit 1233 decodes the audio data and the video data by using the decoder 1252. The recording/reproducing unit 1233 performs a D/A conversion on the decoded audio data and outputs the result to the speaker of the monitor 1260. The recording/reproducing unit 1233 also performs a D/A conversion on the decoded video data, and outputs the result to the display of the monitor 1260.

Based on a user's instruction indicated by an infrared signal that is transmitted from a remote controller and is received via the reception unit 1221, the recorder control unit 1226 reads the latest EPG data from the EPG data memory 1227, and supplies the EPG data to the OSD control unit 1231. The OSD control unit 1231 generates image data corresponding to the input EPG data, and outputs the image data to the display control unit 1232. The display control unit 1232 outputs the video data input from the OSD control unit 1231 to the display of the monitor 1260, to display the image. In this manner, an EPG (Electronic Program Guide) is displayed on the display of the monitor 1260.

The hard disk recorder 1200 can also obtain various kinds of data, such as video data, audio data and EPG data, which are supplied from another apparatus via a network such as the Internet.

Under the control of the recorder control unit 1226, the communication unit 1235 obtains encoded data of video data, audio data, EPG data, and the like from another apparatus via a network, and supplies those data to the recorder control unit 1226. For example, the recorder control unit 1226 supplies encoded data of obtained video data and audio data to the recording/reproducing unit 1233, and stores those data into the hard disk. At this point, the recorder control unit 1226 and the recording/reproducing unit 1233 may perform an operation such as a re-encoding where necessary.

The recorder control unit 1226 also decodes encoded data of obtained video data and audio data, and supplies the resultant video data to the display converter 1230.

The display converter 1230 processes the video data supplied from the recorder control unit 1226 in the same manner as processing video data supplied from the video decoder 1225, and supplies the result to the monitor 1260 via the display control unit 1232, to display the image.

In synchronization with the image display, the recorder control unit 1226 may supply the decoded audio data to the monitor 1260 via the D/A converter 1234, and output the sound from the speaker.

Further, the recorder control unit 1226 decodes encoded data of obtained EPG data, and supplies the decoded EPG data to the EPG data memory 1227.

The above described hard disk recorder 1200 uses image decoding apparatuses 200 as the video decoder 1225, the decoder 1252, and the decoder built into the recorder control unit 1226. That is, when performing a motion vector information decoding operation using the correlation in the temporal direction as in the case of the image decoding apparatus 200, the video decoder 1225, the decoder 1252, and the decoder in the recorder control unit 1226 each store only the motion vector information about a sub macroblock of each macroblock into the motion vector buffer of the temporal motion vector decoding unit 221, and calculate the motion vector information about the other sub macroblocks by performing an interpolating operation or the like using other motion vector information stored in the motion vector buffer. Thus, the video decoder 1225, the decoder 1252, and the decoder in the recorder control unit 1226 can reduce the amount of motion vector information to be stored in the motion vector buffer, and reduce the load of the motion vector information decoding operation using the correlation in the temporal direction.

Accordingly, in a case where video data (encoded data) received by a tuner or the communication unit 1235 and video data (encoded data to be reproduced by the recording/reproducing unit 1233 are encoded in a mode for performing a motion vector information coding operation using the correlation in the temporal direction, for example, the hard disk recorder 1200 can reduce the amount of memory required in the decoding operation, and reduce the load.

The hard disk recorder 1200 also uses the image coding apparatus 100 as the encoder 1251. Accordingly, when performing a motion vector information coding operation using the correlation in the temporal direction as in the case of the image coding apparatus 100, the encoder 1251 stores only the motion vector information about a sub macroblock of each macroblock into the motion vector buffer 183 of the temporal motion vector coding unit 121, and calculates the motion vector information about the other sub macroblocks by performing an interpolating operation or the like using other motion vector information stored in the motion vector buffer 183. Thus, the encoder 1251 can reduce the amount of motion vector information to be stored in the motion vector buffer 183, and reduce the load of the motion vector information coding operation using the correlation in the temporal direction.

Accordingly, in a case where image data to be recorded is encoded in a mode for performing a motion vector information coding operation using the correlation in the temporal direction when encoded data to be recorded on the hard disk is venerated, the hard disk recorder 1200 can reduce the amount of memory required in the coding operation, and reduce the load.

In the above description, the hard disk recorder 1200 that records video data and audio data on a hard disk has been described. However, any other recording medium may be used. For example, as in the case of the above described hard disk recorder 1200, the image coding apparatus 100 and the image decoding apparatus 200 can be applied to a recorder that uses a recording medium other than a hard disk, such as a flash memory, an optical disk, or a videotape.

### 7. Seventh Embodiment

### [Camera]

FIG. 25 is a block diagram showing an example principal structure of a camera using the image coding apparatus 100 and the image decoding apparatus 200.

The camera 1300 shown in FIG. 25 captures an image of an object, and displays the image of the object on an LCD 1316 or records the image of the object as image data on a recording medium 1333.

A lens block 1311 has light (or a video image of an object) incident on a CCD/CMOS 1312. The CCD/CMOS 1312 is an image sensor using a CCD or a CMOS. The CCD/CMOS 1312 converts the intensity of the received light into an electrical signal, and supplies the electrical signal to a camera signal processing unit 1313.

The camera signal processing unit 1313 transforms the electrical signal supplied from the CCD/CMOS 1312 into a YCrCb chrominance signal, and supplies the signal to an image signal processing unit 1314. Under the control of a controller 1321, the image signal processing unit 1314 performs predetermined image processing on the image signal supplied from the camera signal processing unit 1313, and encodes the image signal by using an encoder 1341. The image signal processing unit 1314 supplies the encoded data generated by encoding the image signal to a decoder 1315. The image signal processing unit 1314 further obtains display data generated at an on-screen display (OSD) 1320, and supplies the display data to the decoder 1315.

In the above operation, the camera signal processing unit 1313 uses a DRAM (Dynamic Random Access Memory) 1318 connected thereto via a bus 1317, to store the image data, the encoded data generated by encoding the image data, and the like into the DRAM 1318 where necessary.

The decoder 1315 decodes the encoded data supplied from the image signal processing unit 1314, and supplies the resultant image data (decoded image data) to the LCD 1316. The decoder 1315 also supplies the display data supplied from the image signal processing unit 1314 to the LCD 1316. The LCD 1316 combines the image corresponding to the decoded image data supplied from the decoder 1315 with the image corresponding to the display data, and displays the combined image.

Under the control of the controller 1321, the on-screen display 1320 outputs the display data of a menu screen or icons formed with symbols, characters, or figures, to the image signal processing unit 1314 via the bus 1317.

Based on a signal indicating contents designated by a user using an operation unit 1322, the controller 1321 performs various operations, and controls, via the bus 1317, the image signal processing unit 1314, the DRAM 1318, an external interface 1319, the on-screen display 1320, a media drive 1323, and the like. A flash ROM 1324 stores programs, data, and the like necessary for the controller 1321 to perform various operations.

For example, in place of the image signal processing unit 1314 and the decoder 1315, the controller 1321 can encode the image data stored in the DRAM 1318, and decode the encoded data stored in the DRAM 1318. In doing so, the controller 1321 may perform coding and decoding operations by using the same methods as the coding and decoding methods used by the image signal processing unit 1314 and the decoder 1315, or may perform coding and decoding operations by using methods that are not used by the image signal processing unit 1314 and the decoder 1315.

In a case where a start of image printing is requested through the operation unit 1322, for example, the controller 1321 reads image data from the DRAM 1318, and supplies the image data to a printer 1334 connected to the external interface 1319 via the bus 1317, so that the printing is performed.

Further, in a case where image recording is requested through the operation unit 1322, for example, the controller 1321 reads encoded data from the DRAM 1318, and supplies and stores the encoded data into the recording medium 1333 mounted on the media drive 1323 via the bus 1317.

The recording medium 1333 is a readable and writable removable medium, such as a magnetic disk, a magneto-optical disk, an optical disk, or a semiconductor memory. The recording medium 1333 may be any kind of removable medium, and may be a tape device, a disk, or a memory card. It is of course possible to use a non-contact IC card or the like.

The media drive 1323 and the recording medium 1333 may be integrated, to form a non-portable storage medium such as an internal hard disk drive or a SSD (Solid-State Drive).

The external interface 1319 is formed with a USB input/output terminal or the like, and is connected to the printer 1334 when image printing is performed. Also, a drive 1331 is connected to the external interface 1319 where necessary, and a removable medium 1332 such as a magnetic disk, an optical disk, or a magneto-optical disk is mounted on the drive 1331 where appropriate. A computer program that is read from such a disk is installed in the flash ROM 1324 where necessary.

Further, the external interface 1319 includes a network interface connected to a predetermined network such as a LAN or the Internet. In accordance with an instruction from the operation unit 1322, for example, the controller 1321 can read encoded data from the DRAM 1318, and supply the encoded data from the external interface 1319 to another apparatus connected thereto via a network. Also, the controller 1321 can obtain, via the external interface 1319, encoded data and image data supplied from another apparatus via a network, and store the data into the DRAM 1318 or supply the data to the image signal processing unit 1314.

The above camera 1300 uses the image decoding apparatus 200 as the decoder 1315. That is, when performing a motion vector information decoding operation using the correlation in the temporal direction as in the case of the image decoding apparatus 200, the decoder 1315 stores only the motion vector information about a sub macroblock of each macroblock into the motion vector buffer of the temporal motion vector decoding unit 221, and calculates the motion vector information about the other sub macroblocks by performing an interpolating operation or the like using other motion vector information stored in the motion vector buffer. Thus, the decoder 1315 can reduce the amount of motion vector information to be stored in the motion vector buffer, and reduce the load of the motion vector information decoding operation using the correlation in the temporal direction.

Accordingly, in a case where image data generated by the CCD/CMOS 1312, encoded data of video data read from the DRAM 1318 or the recording medium 1333, or encoded data of vide data obtained via a network is encoded in a mode for performing a motion vector information coding operation using the correlation in the temporal direction, for example, the camera 1300 can reduce the amount of memory required in the decoding operation, and reduce the load.

Also, the camera 1300 uses the image coding apparatus 100 as the encoder 1341. When performing a motion vector information coding operation using the correlation in the temporal direction as in the case of the image coding apparatus 100, the encoder 1341 stores only the motion vector information about a sub macroblock of each macroblock into the motion vector buffer 183 of the temporal motion vector coding unit 121, and calculates the motion vector information about the other sub macroblocks by performing an interpolating operation or the like using other motion vector information stored in the motion vector buffer 183. Thus, the encoder 1341 can reduce the amount of motion vector information to be stored in the motion vector buffer 163, and reduce the load of the motion vector information coding operation using the correlation in the temporal direction.

Accordingly, in a case where image data to be recorded or provided is encoded in a mode for performing a motion vector information coding operation using the correlation in the temporal direction when the encoded data to be recorded on the DRAM 1318 or the recording medium 1333 or the encoded data to be provided to another apparatus is generated, for example, the camera 1300 can reduce the amount of memory required in the coding operation, and reduce the load.

The decoding method used by the image decoding apparatus 200 may be applied to decoding operations to be performed by the controller 1321. Likewise, the coding method used by the image coding apparatus 100 may be applied to coding operations to be performed by the controller 1321.

Image data to be captured by the camera 1300 may be of a moving image, or may be of a still image.

It is of course possible to apply the image coding apparatus 100 and the image decoding apparatus 200 to any apparatuses and systems other than the above described apparatuses.

The present invention can be applied to image encoding apparatuses and image decoding apparatuses used for processing image information (bit streams) compressed through orthogonal transforms such as discrete cosine transforms and motion compensations as in MPEG and H.26x in a storage medium such as an optical disk, a magnetic disk, or a flash memory, upon receipt of the image information via a network medium such as satellite broadcasting, cable television broadcasting, the Internet, or a portable telephone.

This technique can also be embodied in the following structures.

(1) An image processing apparatus that operates in a coding mode in which the motion vector information about a current small region is encoded by using the motion vector information about a reference small region located in the same position in a reference frame as the current small region and using the temporal correlation of the motion vector information, the current small region being formed by dividing a current partial region of a current frame image into small regions,

the image processing apparatus including:

a motion vector information storage unit that stores the motion vector information about one small region among the small regions of each of the partial regions in the reference frame;

a calculation unit that calculates the motion vector information about the reference small region by using the motion vector information stored in the motion vector information storage unit, when the reference small region is a small region not having its motion vector information stored in the motion vector information storage unit; and

a coding unit that encodes the motion vector information about the current small region, by using the motion vector information calculated by the calculation unit and using the temporal correlation of the motion vector information.

(2) The image processing apparatus of (1), wherein the motion vector information storage unit stores the motion vector information about one of the small regions of each one of the partial regions.

(3) The image processing apparatus of (2), wherein the motion vector information storage unit stores the motion vector information about the small region at the uppermost left portion of each partial region.

(4) The image processing apparatus of (1), wherein the motion vector information storage unit, stores the motion vector information about two or more of the small regions of each of the partial regions.

(5) The image processing apparatus of (4), wherein the motion vector information storage unit stores the motion vector information about the small regions at the four corners of each partial region.

(6) The image processing apparatus of one of (1) to (5), wherein the calculation unit calculates the motion vector information about the reference small region by using at least one of the motion vector information that corresponds to the partial region containing the reference small region and is stored in the motion vector information storage unit, and the motion vector information that corresponds to another partial region adjacent to the partial region and is stored in the motion vector information storage unit.

(7) The image processing apparatus of one of (1) to (5), wherein the calculation unit calculates the motion vector information about the reference small region by performing an interpolating operation using the motion vector information that corresponds to the partial region containing the reference small region and is stored in the motion vector information storage unit, and the motion vector information that corresponds to another partial region adjacent to the partial region and is stored in the motion vector information storage unit.

(8) The image processing apparatus of (7), wherein the calculation unit uses values depending on the distances between the representative point of the reference small region and the respective representative points of the partial region containing the reference small region and another partial region adjacent to the partial region, the values being used as weight coefficients in the interpolating operation.

(9) The image processing apparatus of (7), wherein the calculation unit uses values depending on the sizes of the small regions to which the motion vector information used in the interpolating operation corresponds to, the complexities of the images in the small regions, or the similarities of pixel distribution in the small regions, the values being used as weight coefficients in the interpolating operation.

(10) An image processing method implemented in an image processing apparatus compatible with a coding mode in which the motion vector information about a current small region is encoded by using the motion vector information about a reference small region located in the same position in a reference frame as the current small region and using the temporal correlation of the motion vector information, the current small region being formed by dividing a current partial region of a current frame image into small regions,

the image processing method including:

storing the motion vector information about one small region among the small regions of each of the partial regions in the reference frame, the storing being performed by a motion vector information storage unit;

calculating the motion vector information about the reference small region by using the stored motion vector information when the reference small region is a small region not having its motion vector information stored, the calculation being performed by a calculation unit; and

encoding the motion vector information about the current small region, by using the calculated motion vector information and using the temporal correlation of the motion vector information, the encoding being performed by a coding unit.

(11) An image processing apparatus that operates in a coding mode in which the motion vector information about a current small region is encoded by using the motion vector information about a reference small region located in the same position in a reference frame as the current small region and using the temporal correlation of the motion vector information, the current small region being formed by dividing a current partial region of a current frame image into small regions,

the image processing apparatus including:

a motion vector information storage unit that stores the motion vector information about one small region among the small regions of each of the partial regions in the reference frame;

a calculation unit that calculates the motion vector information about the reference small region by using the motion vector information stored in the motion vector information storage unit, when the reference small region is a small region not having its motion vector information stored in the motion vector information storage unit; and

a decoding unit that decodes the motion vector information about the current small region, by using the motion vector information calculated by the calculation unit and using the temporal correlation of the motion vector information, the motion vector information about the current small region having been encoded in the coding mode.

(12) The image processing apparatus of (11), wherein the motion vector information storage unit stores the motion vector information about one of the small regions of each one of the partial regions.

(13) The image processing apparatus of (12), wherein the motion vector information storage unit stores the motion vector information about the small region at the uppermost left portion of each partial region.

(14) The image processing apparatus of (11), wherein the motion vector information storage unit stores the motion vector information about two or more of the small regions of each of the partial regions.

(15) The image processing apparatus of (14), wherein the motion vector information storage unit stores the motion vector information about the small regions at the four corners of each partial region.

(16) The image processing apparatus of one of (11) to (15), wherein the calculation unit calculates the motion vector information about the reference small region by using at least one of the motion vector information that corresponds to the partial region containing the reference small region and is stored in the motion vector information storage unit, and the motion vector information that corresponds to another partial region adjacent to the partial region and is stored in the motion vector information storage unit.

(17) The image processing apparatus of one of (11) to (15), wherein the calculation unit calculates the motion vector information about the reference small region by performing an interpolating operation using the motion vector information that corresponds to the partial region containing the reference small region and is stored in the motion vector information storage unit, and the motion vector information that corresponds to another partial region adjacent to the partial region and is stored in the motion vector information storage unit.

(18) The image processing apparatus of (17), wherein the calculation unit uses values depending on the distances between the representative point of the reference small region and the respective representative points of the partial region containing the reference small region and another partial region adjacent to the partial region, the values being used as weight coefficients in the interpolating operation.

(19) The image processing apparatus of (17), wherein the calculation unit uses values depending on the sizes of the small regions to which the motion vector information used in the interpolating operation corresponds to, the complexities of the images in the small regions, or the similaries of pixel distribution in the small regions, the values being used as weight coefficients in the interpolating operation.

(20) An image processing method implemented in an image processing apparatus compatible with a coding mode in which the motion vector information about a current small region is encoded by using the motion vector information about a reference small region located in the same position in a reference frame as the current small region and using the temporal correlation of the motion vector information, the current small region being formed by dividing a current partial region of a current frame image into small regions,

the image processing method including

storing the motion vector information about one small region among the small regions of each of the partial regions in the reference frame, the storing being performed by a motion vector information storage unit;

calculating the motion vector information about the reference small region by using the stored motion vector information when the reference small region is a small region not having its motion vector information stored, the calculation being performed by a calculation unit; and

decoding the motion vector information about the current small region, by using the calculated motion vector information and using the temporal correlation of the motion vector information, the motion vector information about the current small region having been encoded in the coding mode, the decoding being performed by a decoding unit.

### REFERENCE SIGNS LIST

100 Image coding apparatus
115 Motion prediction/compensation unit
121 Temporal motion vector coding unit
181 Block location determining unit
182 Motion vector interpolation unit
183 Motion vector buffer
200 image decoding apparatus
212 Motion prediction/compensation unit
221 temporal motion vector decoding unit

1. An image processing apparatus that operates in a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions,
the image processing apparatus comprising:
a motion vector information storage unit configured to store motion vector information about one small region among small regions of each of partial regions in the reference frame;
a calculation unit configured to calculate the motion vector information about the reference small region by using the motion vector information stored in the motion vector information storage unit, when the reference small region is a small region not having motion vector information thereof stored in the motion vector information storage unit; and
a coding unit configured to encode the motion vector information about the current small region, by using the motion vector information calculated by the calculation unit and using the temporal correlation of the motion vector information.

2. The image processing apparatus according to claim 1, wherein the motion vector information storage unit stores motion vector information about one of the small regions of each one of the partial regions.

3. The image processing apparatus according to claim 2, wherein the motion vector information storage unit stores motion vector information about a small region at the uppermost left portion of each partial region.

4. The image processing apparatus according to claim 1, wherein the motion vector information storage unit stores motion vector information about a plurality of small regions of the small regions of each of the partial regions.

5. The image processing apparatus according to claim 4, wherein the motion vector information storage unit stores motion vector information about small regions at four corners of each partial, region.

6. The image processing apparatus according to claim 1, wherein the calculation unit calculates the motion vector information about the reference small region by using at least one of motion vector information that corresponds to a partial region containing the reference small region and is stored in the motion vector information storage unit, and motion vector information that corresponds to another partial region adjacent to the partial region and is stored in the motion vector information storage unit.

7. The image processing apparatus according to claim 1, wherein the calculation unit calculates the motion vector information about the reference small region by performing an interpolating operation using motion vector information that corresponds to a partial region containing the reference small region and is stored in the motion vector information storage unit, and motion vector information that corresponds to another partial region adjacent to the partial region and is stored in the motion vector information storage unit.

8. The image processing apparatus according to claim 7, wherein the calculation unit uses values depending on distances between a representative point of the reference small region and respective representative points of the partial region containing the reference small region and the another partial region adjacent to the partial region, the values being used as weight coefficients in the interpolating operation.

9. The image processing apparatus according to claim 7, wherein the calculation unit uses values depending on sizes of the small regions to which the motion vector information used in the interpolating operation corresponds to, complexities of images in the small regions, or similarities of pixel distribution in the small regions, the values being used as weight coefficients in the interpolating operation.

10. An image processing method implemented in an image processing apparatus compatible with a coding more in which motion vector information about a current small region is encoded by using motion vector information about a reference small region located in the same position in a reference frame as the current small region and using temporal correlation of the motion vector information, the current small region being formed by dividing a current partial region of a current frame image into small regions,
the image processing method comprising
storing motion vector information about one small region among small regions of each of partial regions in the reference frame, the storing being performed by a motion vector information storage unit;
calculating the motion vector information about the reference small region by using the stored motion vector information when the reference small region is a small region not having motion vector information thereof stored, the calculation being performed by a calculation unit; and
encoding the motion vector information about the current small region, by using the calculated motion vector information and using the temporal correlation of the motion vector information, the encoding being performed by a coding unit.

11. An image processing apparatus that operates in a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions,
the image processing apparatus comprising:
a motion vector information storage unit configured to store motion vector information about one small region among small regions of each of partial regions in the reference frame;
a calculation unit configured to calculate the motion vector information about the reference small region by using the motion vector information stored in the motion vector information storage unit, when the reference small region is a small region not having motion vector information thereof stored in the motion vector information storage unit; and
a decoding unit configured to decode the motion vector information about the current small region, by using the motion vector information calculated by the calculation unit and using the temporal correlation of the motion vector information, the motion vector information about the current small region having been encoded in the coding mode.

12. The image processing apparatus according to claim 11, wherein the motion vector information storage unit stores motion vector information about one of the small regions of each one of the partial regions.

13. The image processing apparatus according to claim 12, wherein the motion vector information storage unit stores motion vector information about a small region at the uppermost left portion of each partial region.

14. The image processing apparatus according to claim 11, wherein the motion vector information storage unit stores motion vector information about a plurality of small regions of the small regions of each of the partial regions.

15. The image processing apparatus according to claim 14, wherein the motion vector information storage unit stores motion vector information about small regions at four corners of each partial region.

16. The image processing apparatus according to claim 11, wherein the calculation unit calculates the motion vector information about the reference small region by using at least one of motion vector information that corresponds to a partial region containing the reference small region and is stored in the motion vector information storage unit, and motion vector information that corresponds to another partial region adjacent to the partial region and is stored in the motion vector information storage unit.

17. The image processing apparatus according to claim 11, wherein the calculation unit calculates the motion vector information about the reference small region by performing an interpolating operation using motion vector information that corresponds to a partial region containing the reference small region and is stored in the motion vector information storage unit, and motion vector information that corresponds to another partial region adjacent to the partial region and is stored in the motion vector information storage unit.

18. The image processing apparatus according to claim 17, wherein the calculation unit uses values depending on distances between a representative point of the reference small region and respective representative points of the partial region containing the reference small region and the another partial region adjacent to the partial region, the values being used as weight coefficients in the interpolating operation.

19. The image processing apparatus according to claim 17, wherein the calculation unit uses values depending on sizes of the small regions to which the motion vector information used in the interpolating operation corresponds, complexities of images in the small regions, or similarities of pixel distribution in the small regions, the values being used as weight coefficients in the interpolating operation.

20. An image processing method implemented in an image processing apparatus compatible with a coding mode in which motion vector information about a current small region is encoded by using motion vector information about a reference small region located in the same position in a reference frame as the current small region and using temporal correlation of the motion vector information, the current small region being formed by dividing a current partial region of a current frame image into small regions,
the image processing method comprising:
storing motion vector information about one small region among small regions of each of partial regions in the reference frame, the storing being performed by a motion vector information storage unit;
calculating the motion vector information about the reference small region by using the stored motion vector information when the reference small region is a small region not having motion vector information thereof stored, the calculation being performed by a calculation unit; and
decoding the motion vector information about the current small region, by using the calculated motion vector information and using the temporal correlation of the motion vector information, the motion vector information about the current small region having been encoded in the coding mode, the decoding being performed by a decoding unit.
